(19) United States
(12) Patent Application Publication
(10) Pub. No.: US 2021/0049626 A1
(43) Pub. Date: Feb. 18, 2021

(54) COMPUTER-READABLE RECORDING MEDIUM RECORDING ANALYSIS PROGRAM, ANALYSIS METHOD, AND ANALYZER

(71) Applicant: FUJITSU LIMITED, Kawasaki-shi (JP)

(72) Inventors: Yuki Ishiguro, Odawara (JP); Naofumi IWASA, Yokohama (JP); Shouta Watanabe, Zushi (JP)

(73) Assignee: FUJITSU LIMITED, Kawasaki-shi (JP)

(21) Appl. No.: 17/088,726

(22) Filed: Nov. 4, 2020

Related U.S. Application Data
(63) Continuation of application No. PCT/JP2018/018617, filed on May 14, 2018.

(51) Int. Cl. G06Q 30/02; G06F 40/279; G06F 3/14; H04L 12/58; G06Q 30/00; G06F 16/9538; G06F 16/9535

(52) U.S. Cl. CPC G06Q 30/0203; G06F 40/279; G06F 3/14; G06F 3/0482; G06Q 30/016; G06F 16/9538; G06F 16/9535; H04L 51/02

(57) ABSTRACT

A computer-readable recording medium stores an analysis program for causing a computer to execute processing including: displaying a list of analysis results obtained by referring to a memory that stores inquiry content analyzed on the basis of indexes including an inflow source for an inquiry and a guidance destination for the inquiry and analyzing the inquiry content on the basis of the indexes, in a case where an instruction to display the inquiry content received and collected from terminals is received; and performing narrowing down on other analysis results displayed in the list and displaying analysis results after the narrowing down is performed, in addition to displaying an analysis result after narrowing down is performed on an analysis result in a case where narrowing down of analysis on any one of the analysis results displayed in the list is received.

### CROSS-REFERENCE TO RELATED APPLICATION

This application is a continuation application of International Application PCT/JP2018/018617 filed on May 14, 2018 and designated the U. the entire contents of which are incorporated herein by reference.

### FIELD

The embodiment discussed herein is related to an analysis program, an analysis method, and an analyzer.

### BACKGROUND

In recent years, some FAQ systems, with which a company responds to a customer, use not only a manned chat in which an operator responds but also a chatbot. By using the chatbot, it is possible to respond to the customer out of manned business hours, and it is possible to collect voices of more customers. Then, in the company, by analyzing information collected through a response to the customer by the FAQ system, it is possible to visualize a problem in a service and an interest of the customer and solve the problems.

Japanese Laid-open Patent Publication No. 2006-153628, Japanese Laid-open Patent Publication No. 2010-165292, and Japanese Laid-open Patent Publication No. 2012-238149 are disclosed as related art.

### SUMMARY

According to an aspect of the embodiments, a non-transitory computer-readable recording medium stores therein an analysis program for causing a computer to execute processing including: displaying a list of a plurality of analysis results obtained by referring to a memory that stores inquiry content analyzed on the basis of a plurality of indexes including an inflow source for an inquiry and a guidance destination for the inquiry and analyzing the inquiry content on the basis of the plurality of indexes, in a case where an instruction to display the inquiry content received and collected from a plurality of terminals is received; and performing narrowing down on other analysis results displayed in the list and displaying a plurality of analysis results after the narrowing down is performed, in addition to displaying an analysis result after narrowing down is performed on an analysis result in a case where narrowing down of analysis on any one of the plurality of analysis results displayed in the list is received.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a configuration of an FAQ system;

FIG. 2 is an explanatory diagram illustrating an example of a chat screen;

FIG. 3 is a block diagram illustrating an exemplary functional configuration of an analyzer according to an embodiment;

FIG. 4 is a flowchart illustrating an exemplary operation of the analyzer according to the embodiment;

FIG. 5 is an explanatory diagram illustrating an example of a dashboard screen;

FIG. 6A is an explanatory diagram illustrating an example of an action number area;

FIG. 66 is an explanatory diagram illustrating an example of a Room number area;

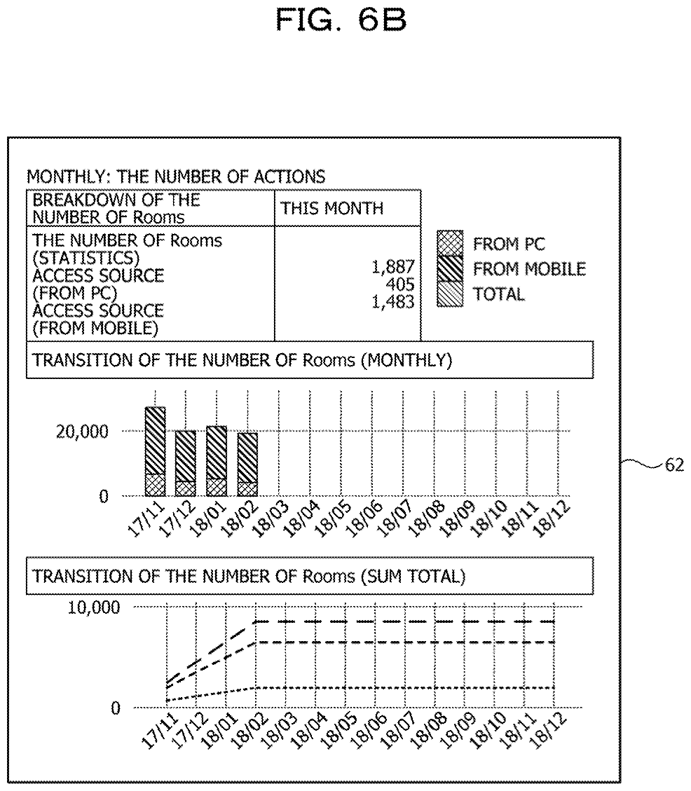

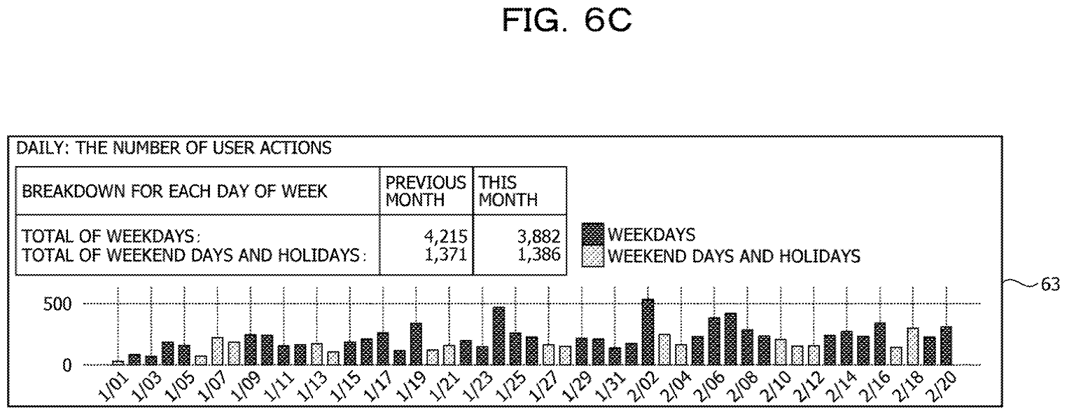

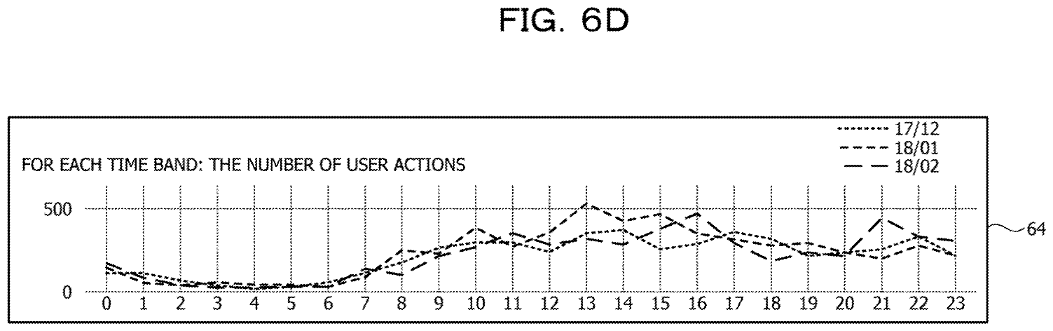

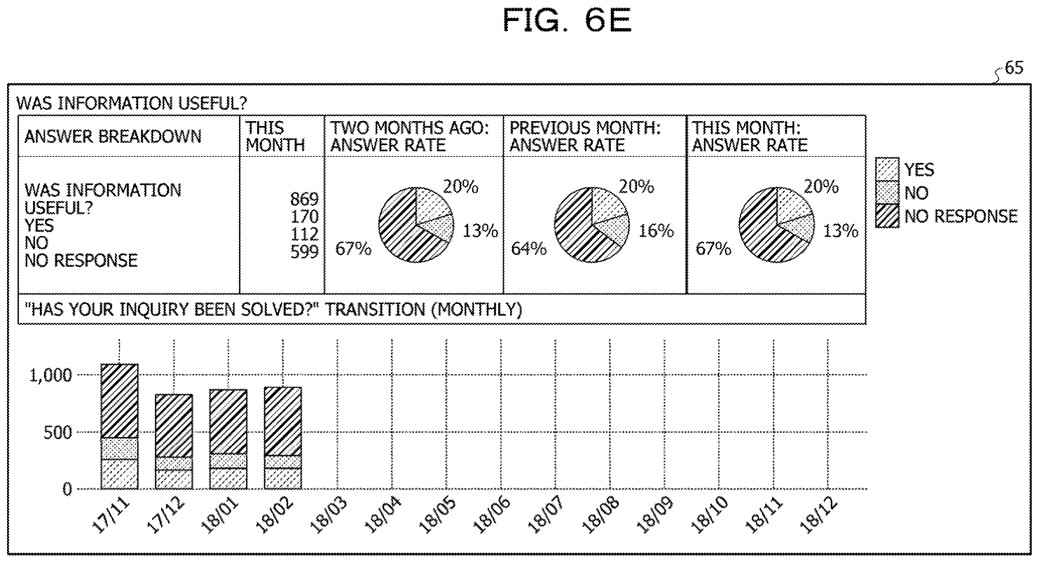

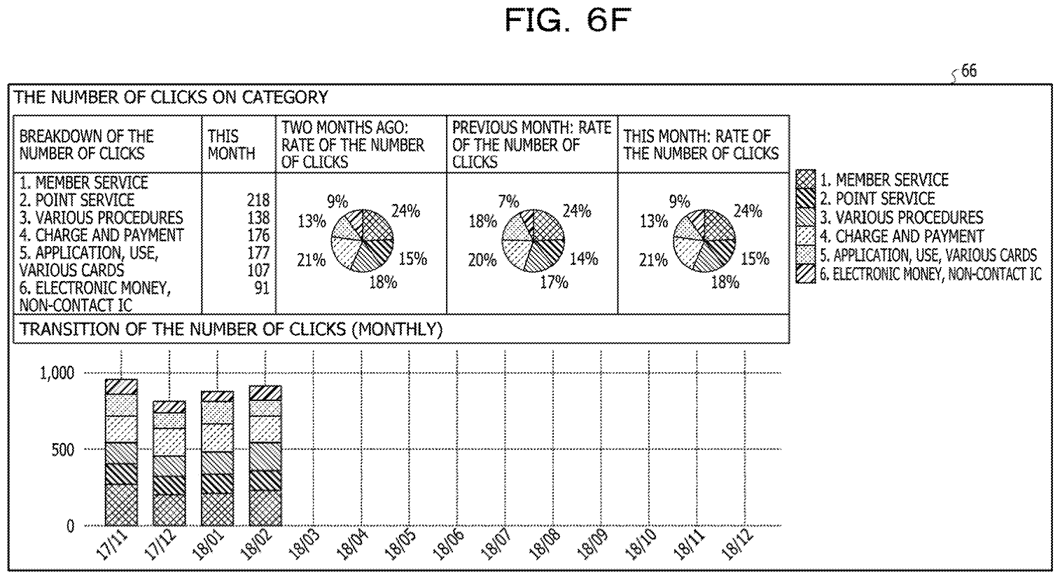

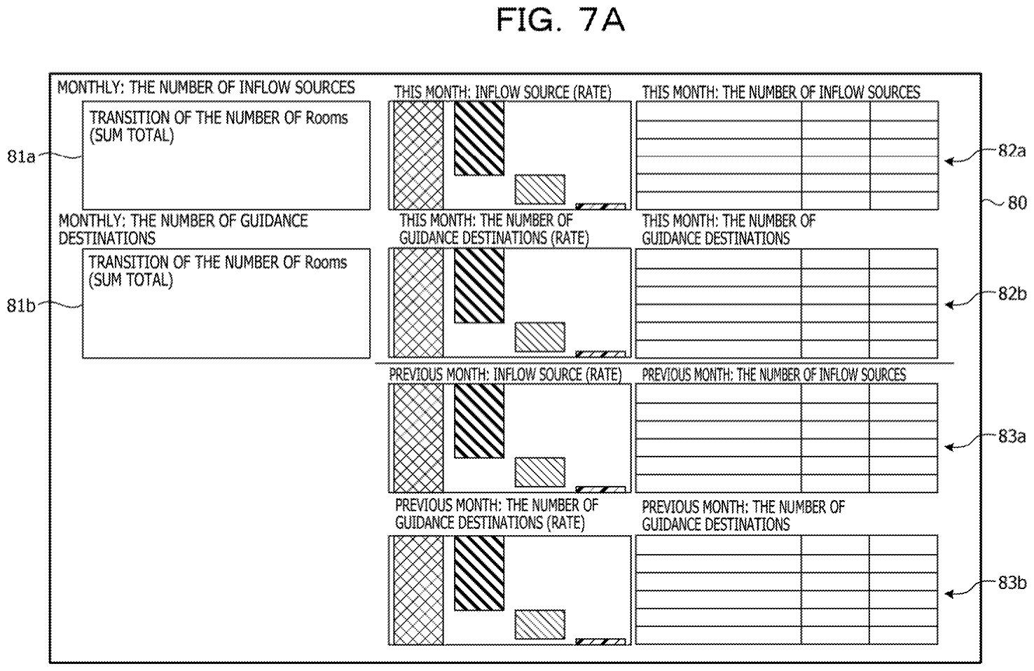

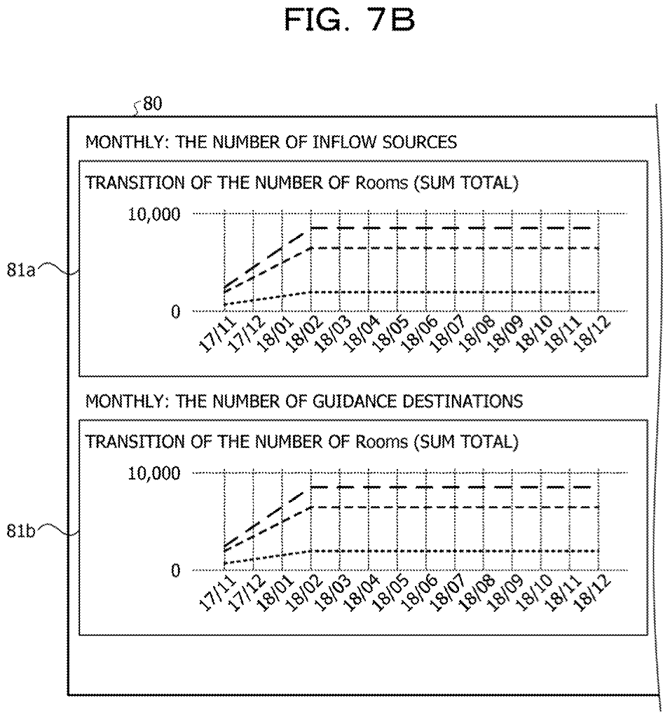

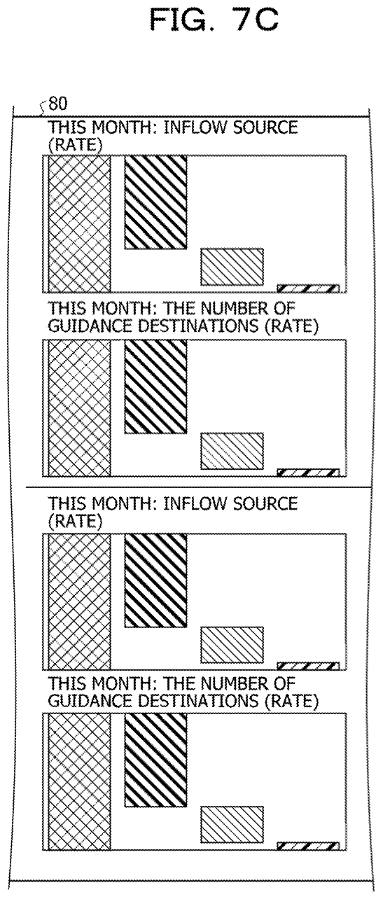

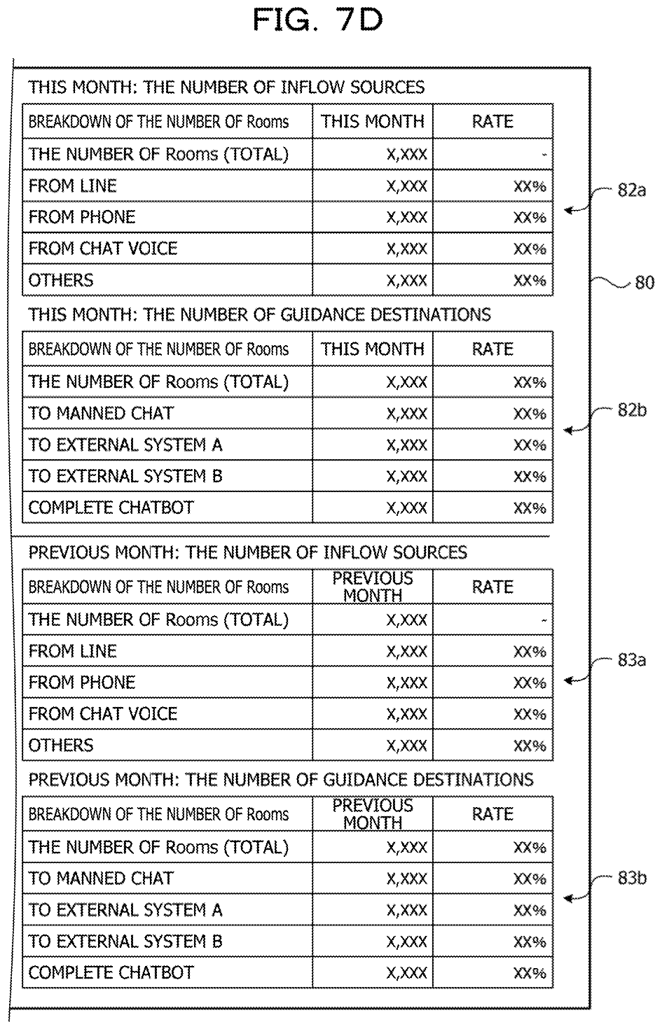

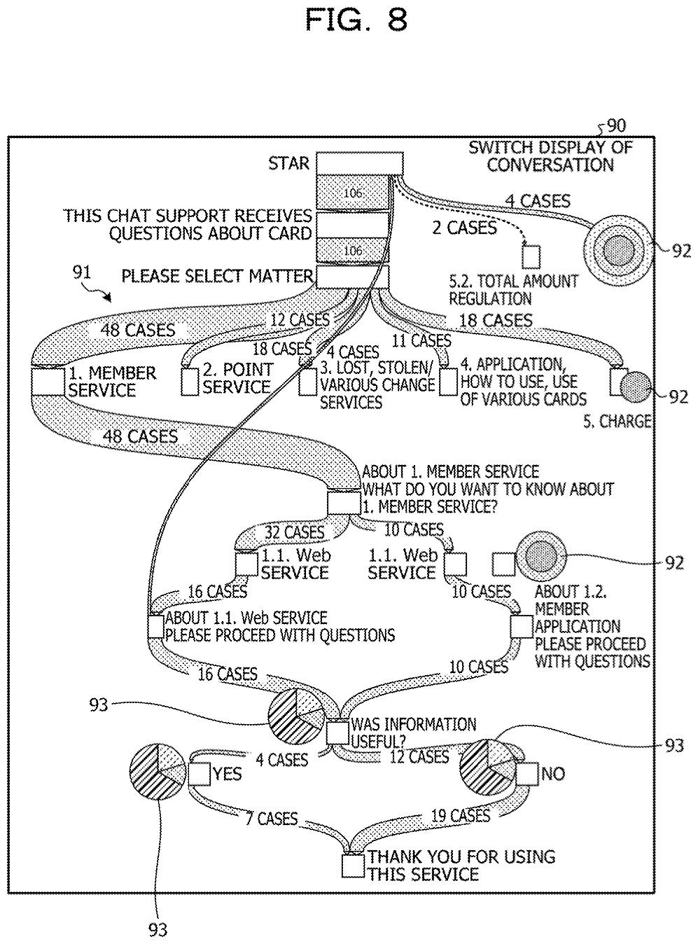

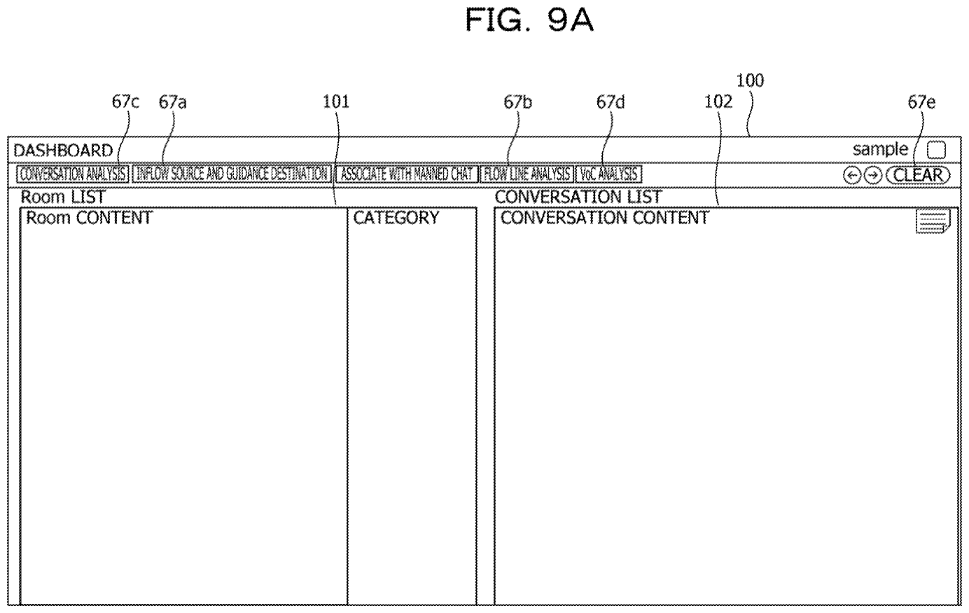

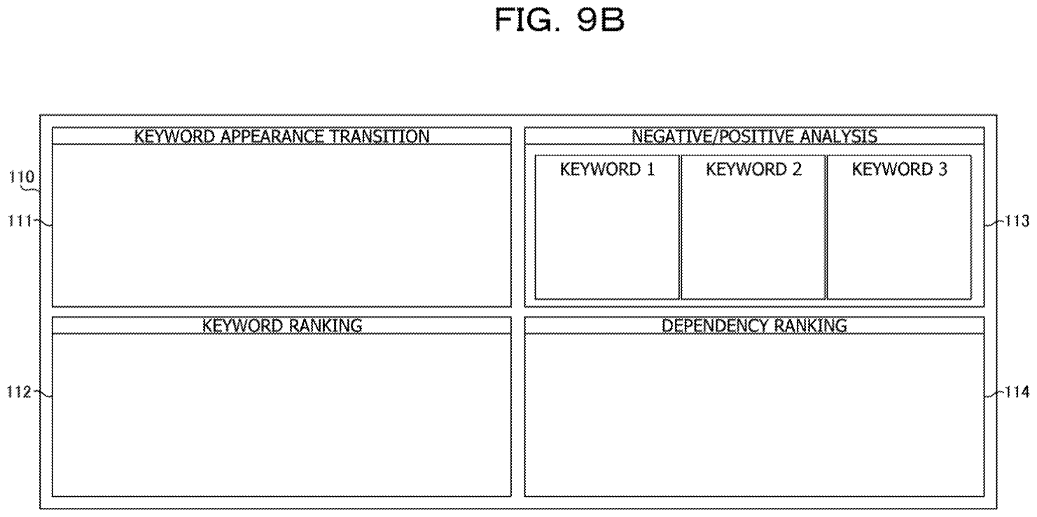

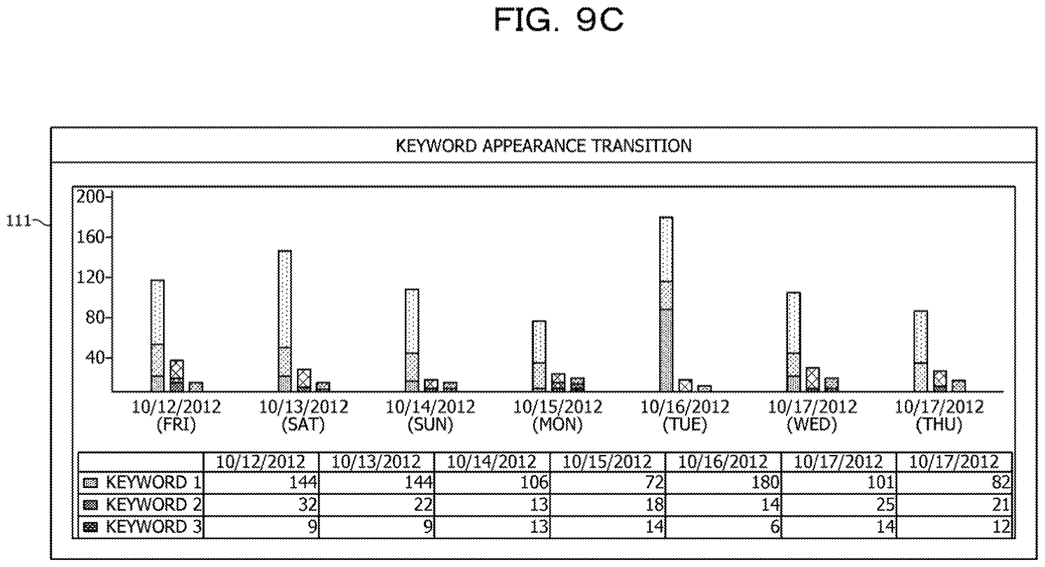

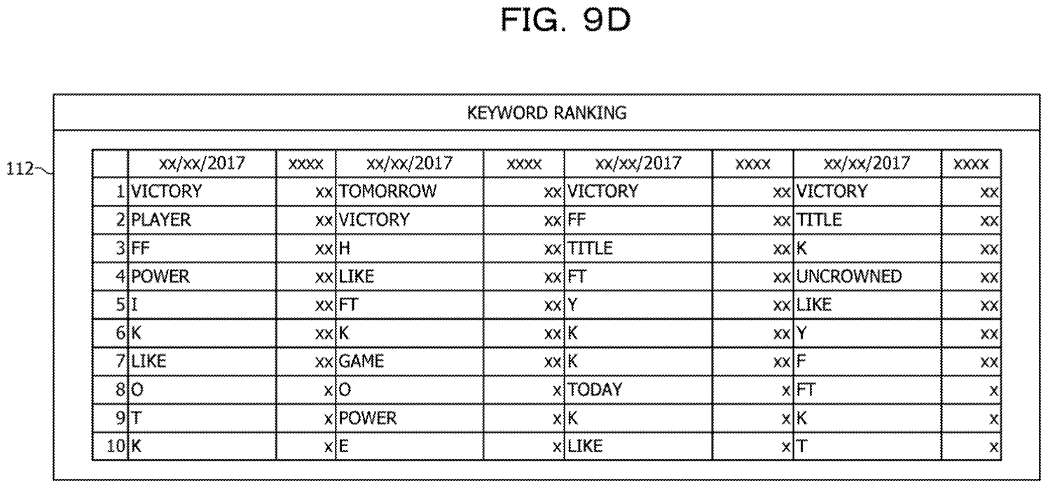

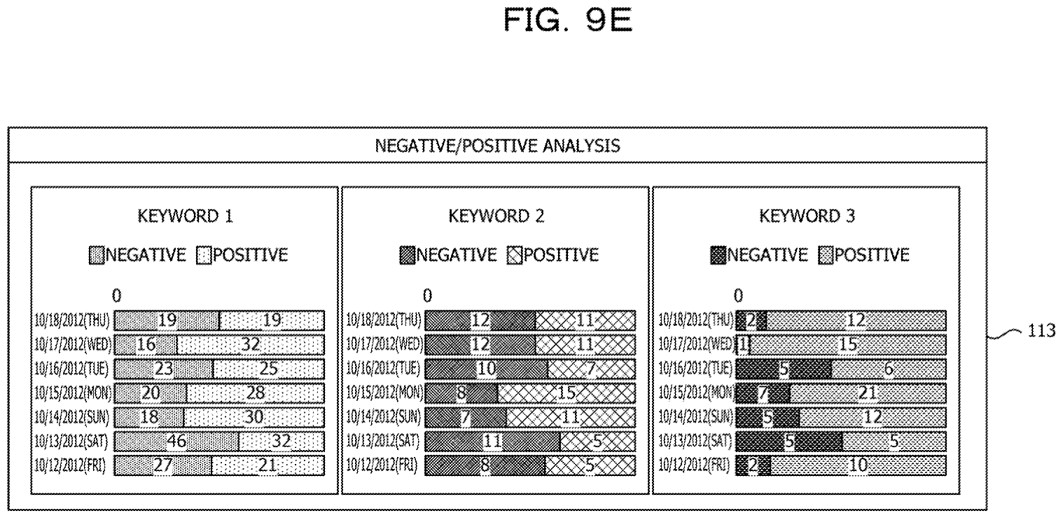

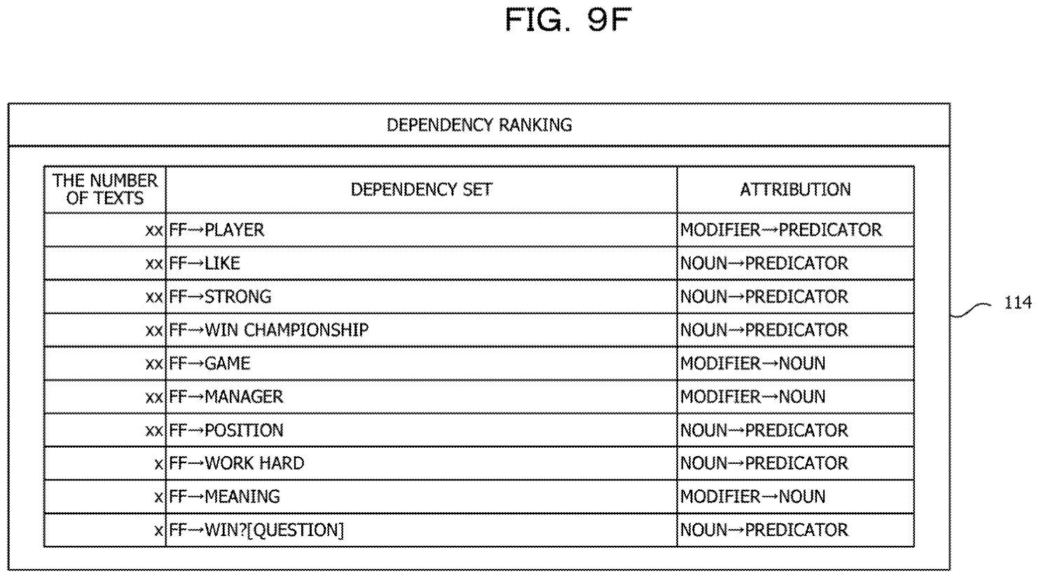

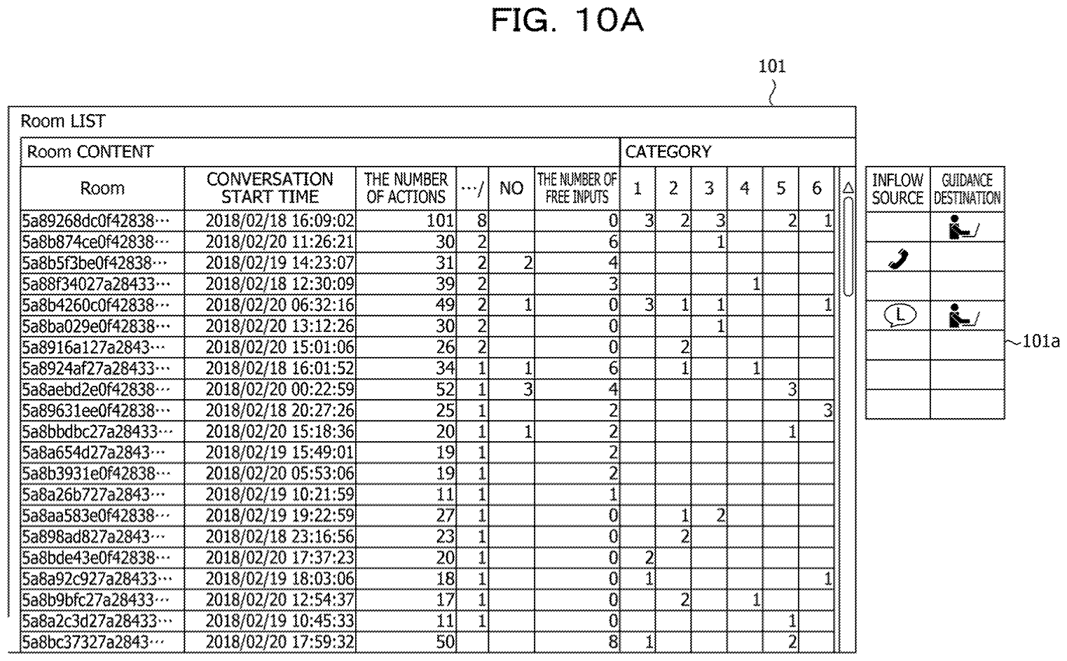

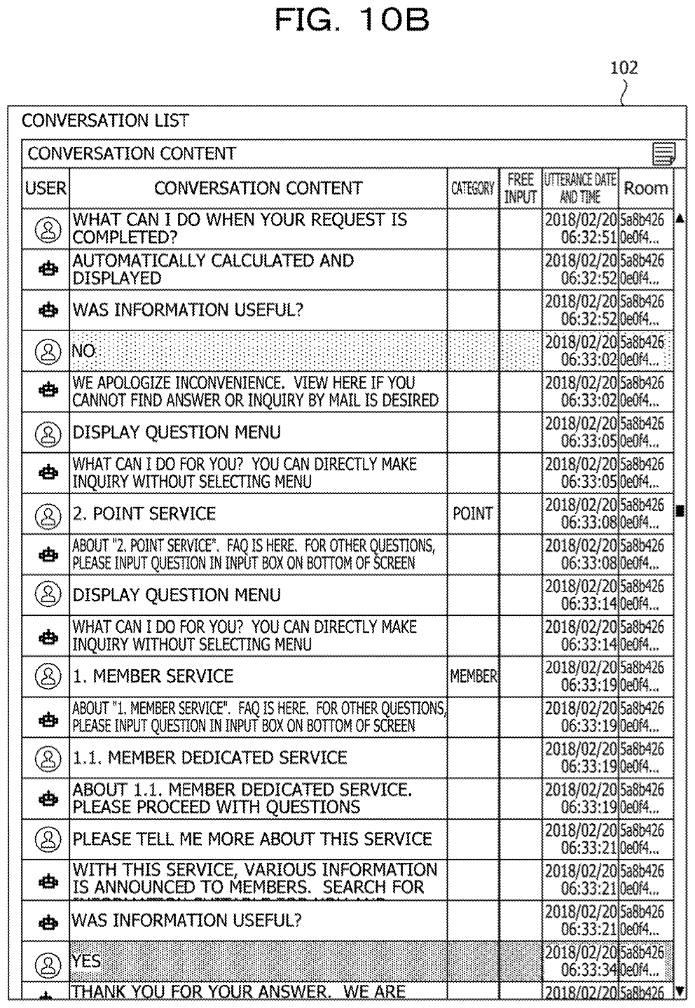

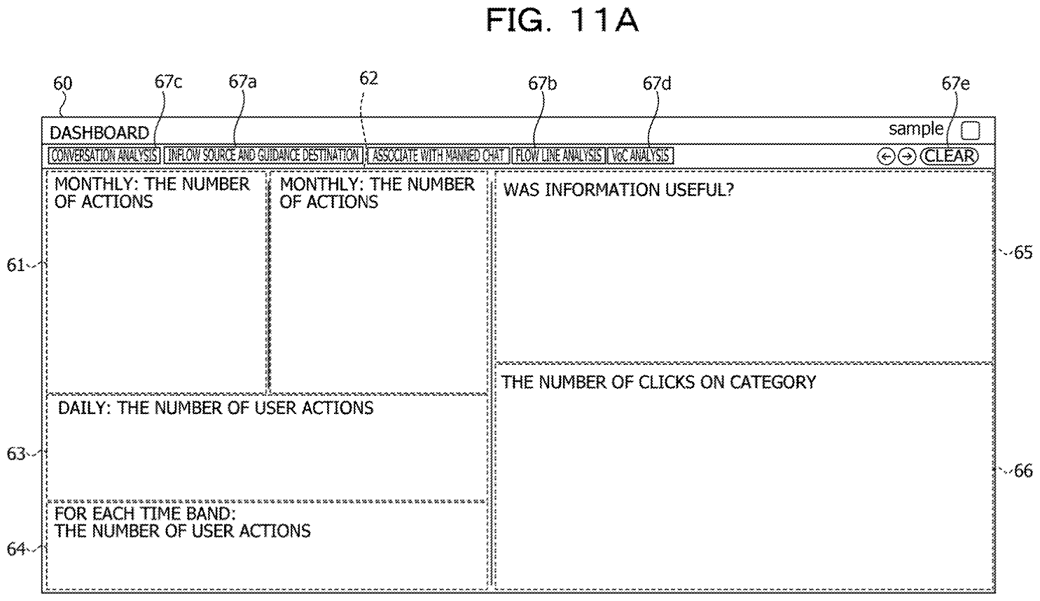

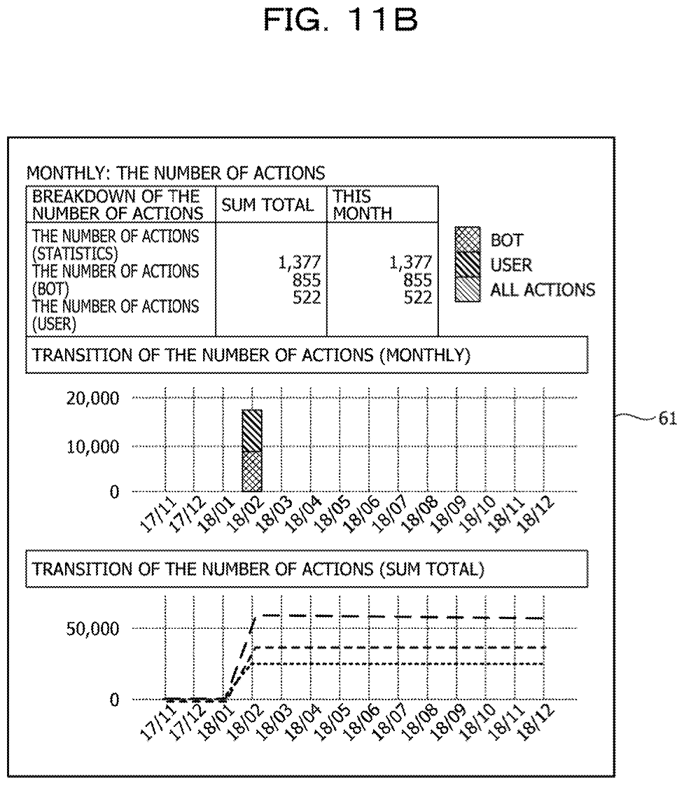

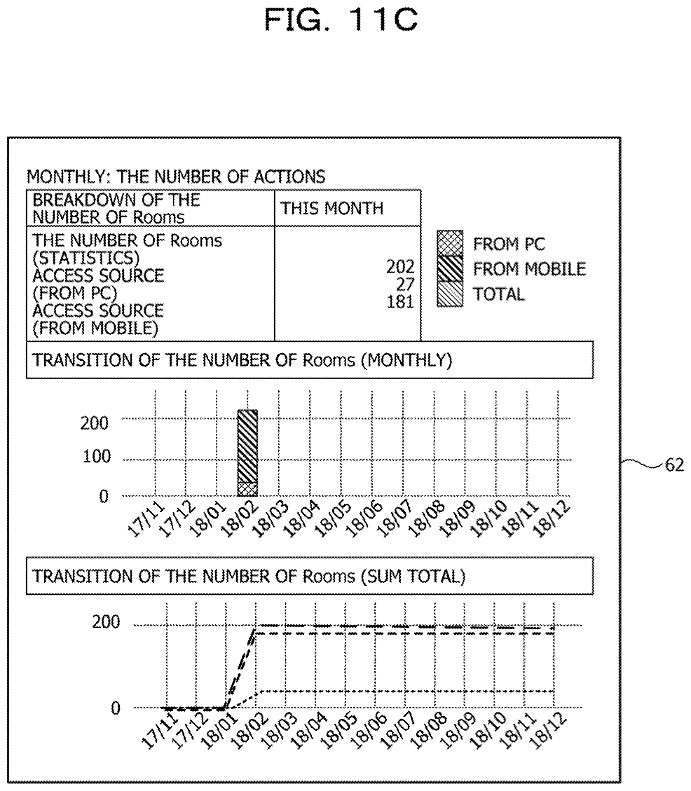

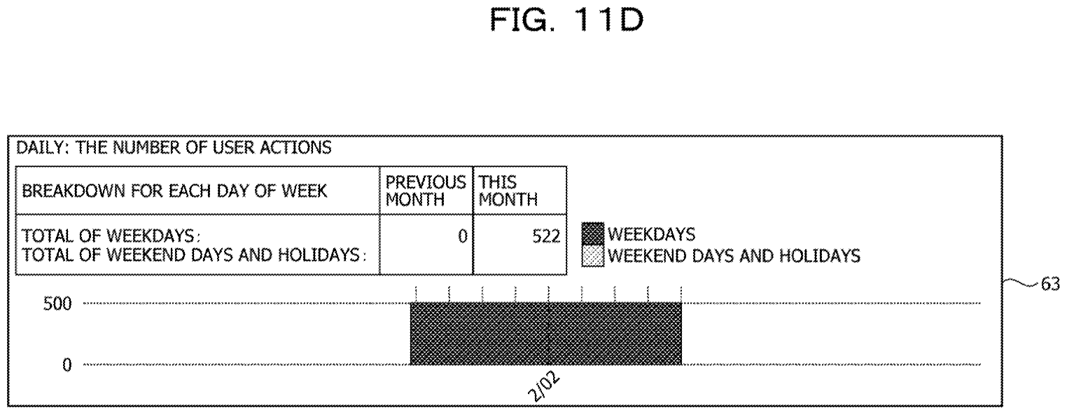

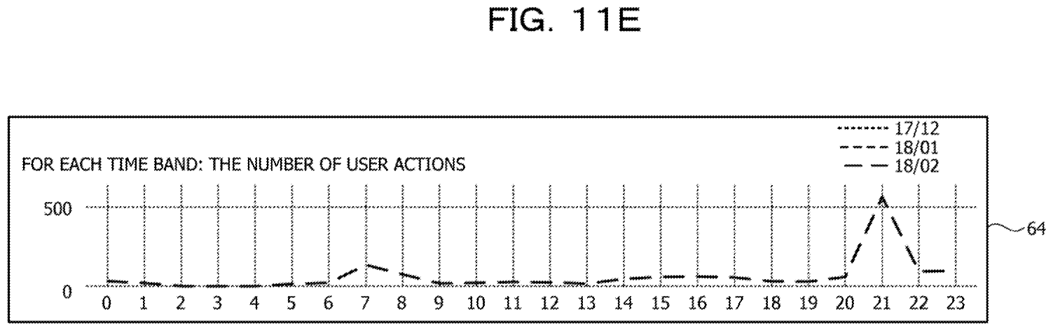

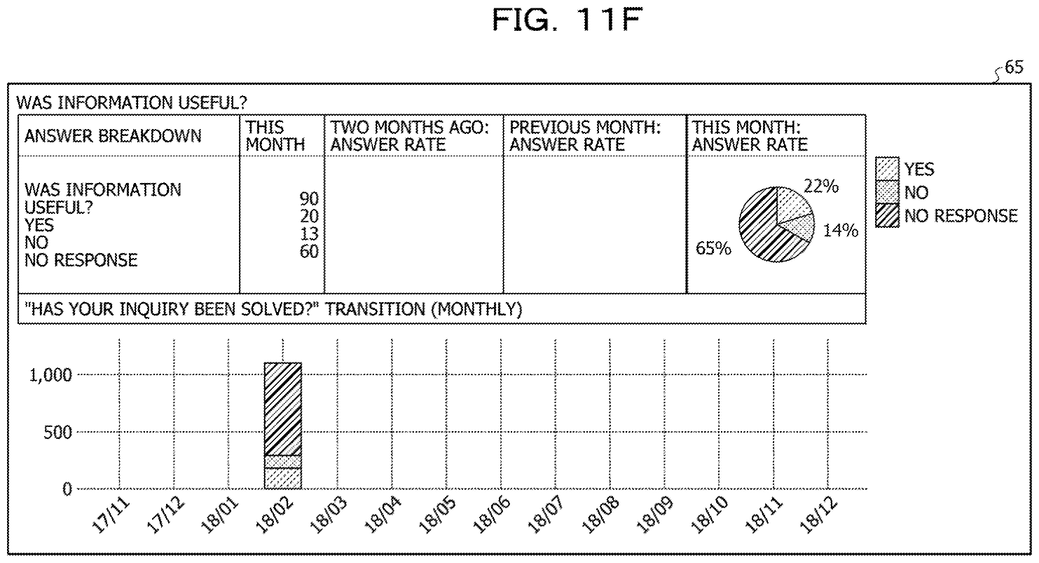

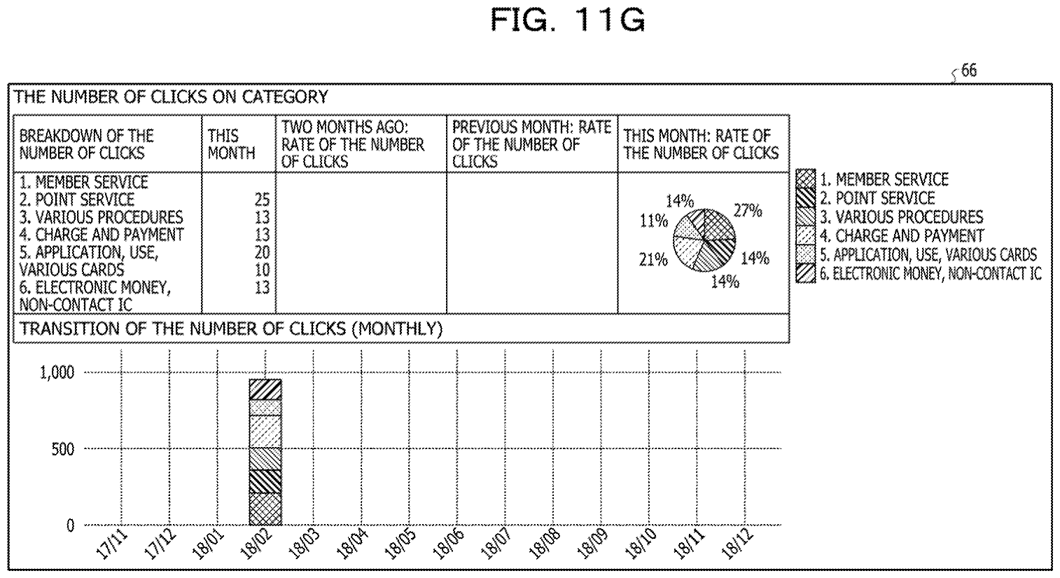

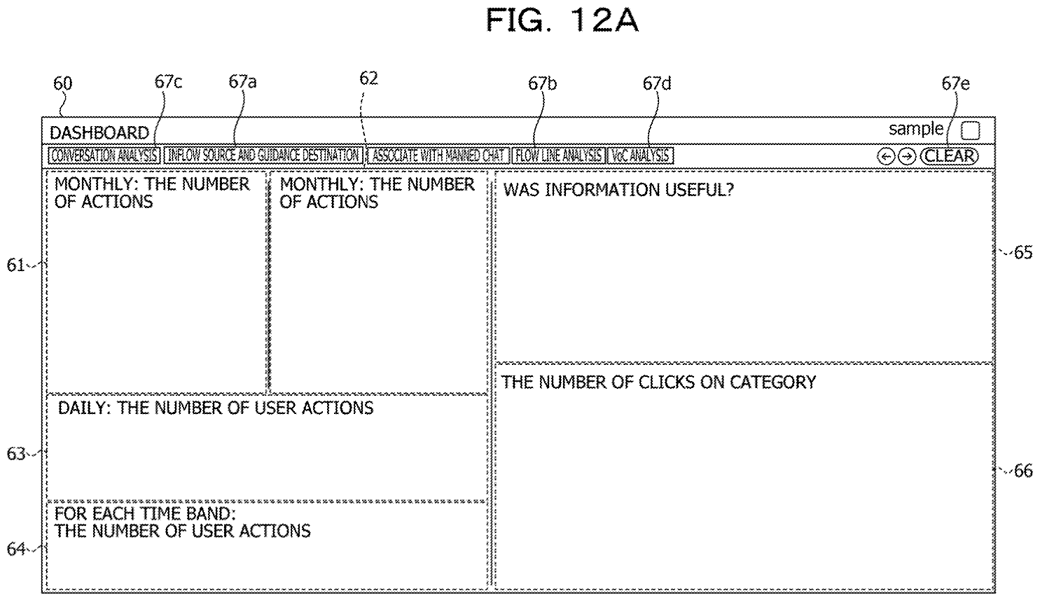

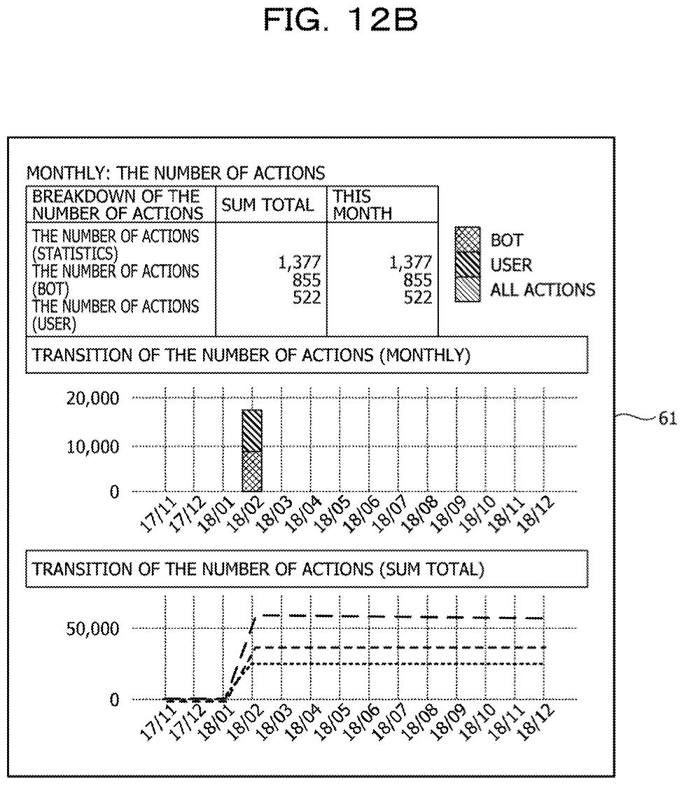

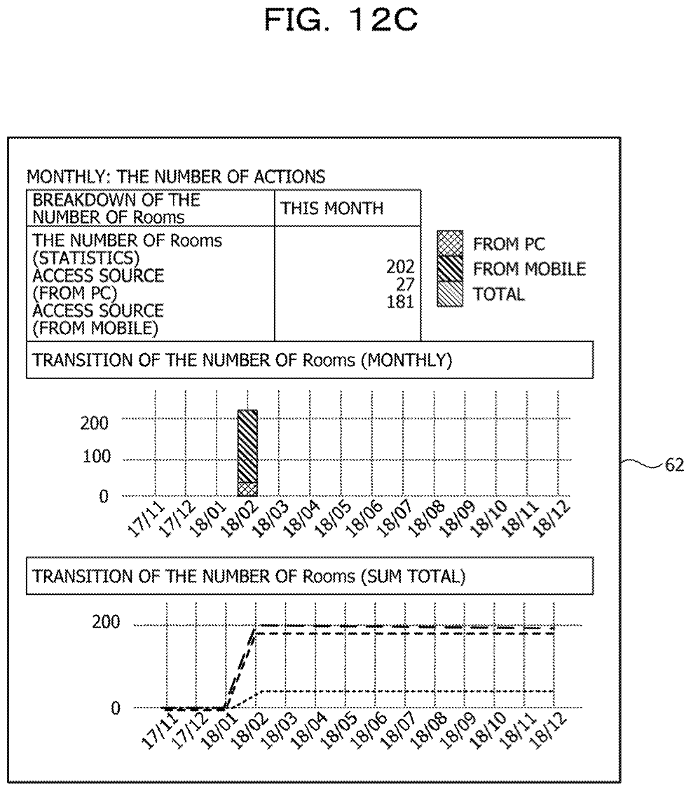

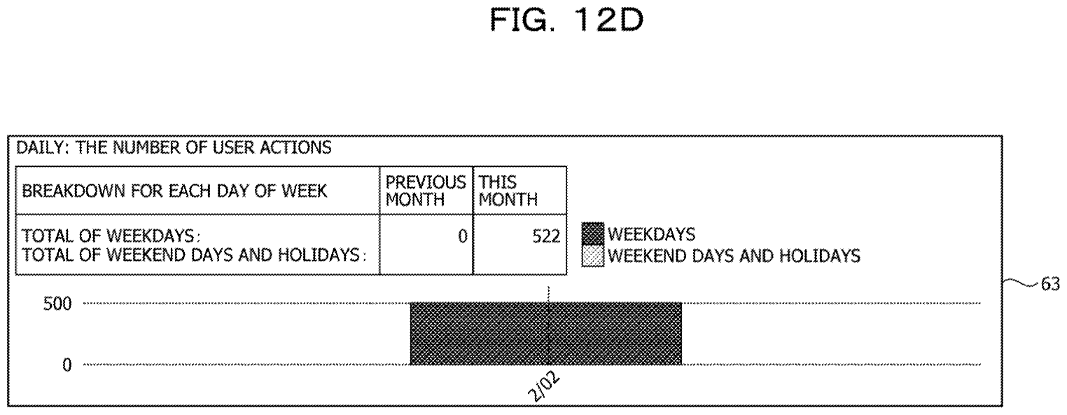

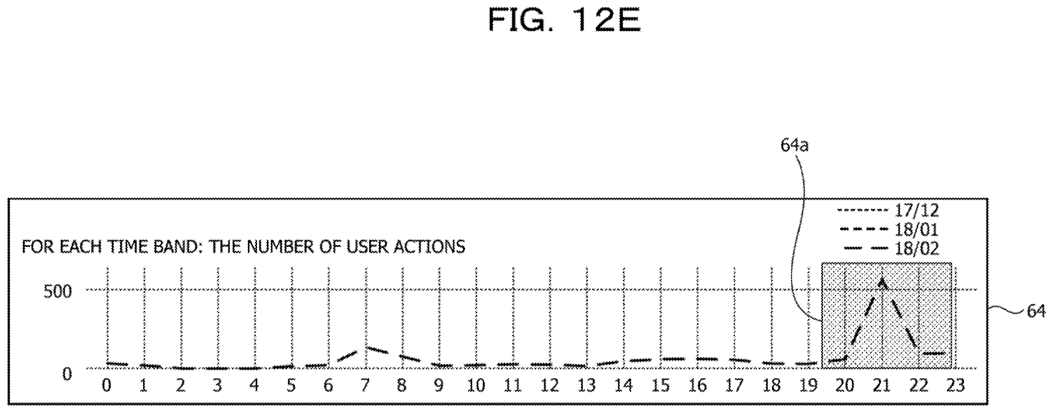

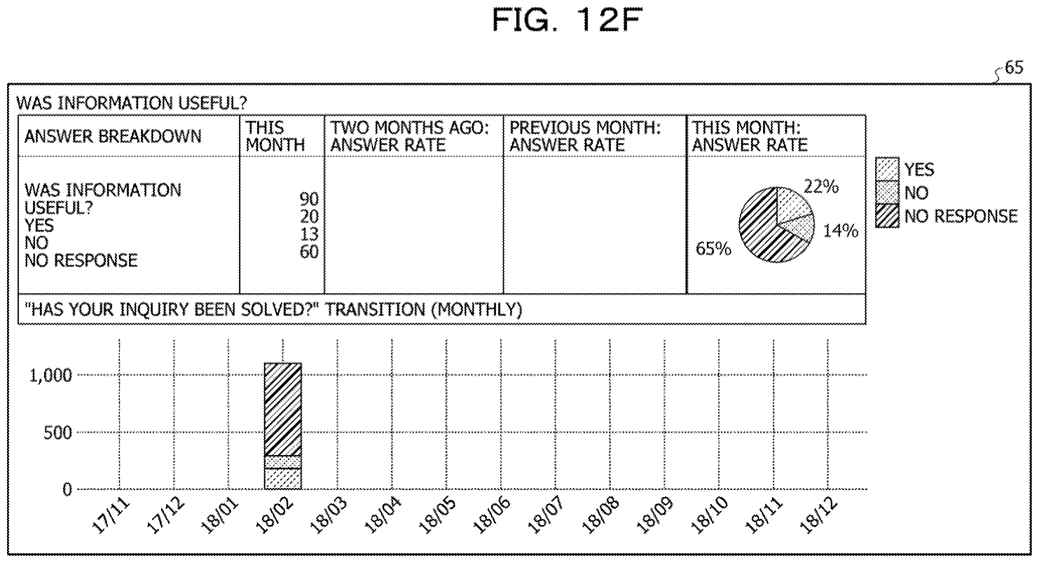

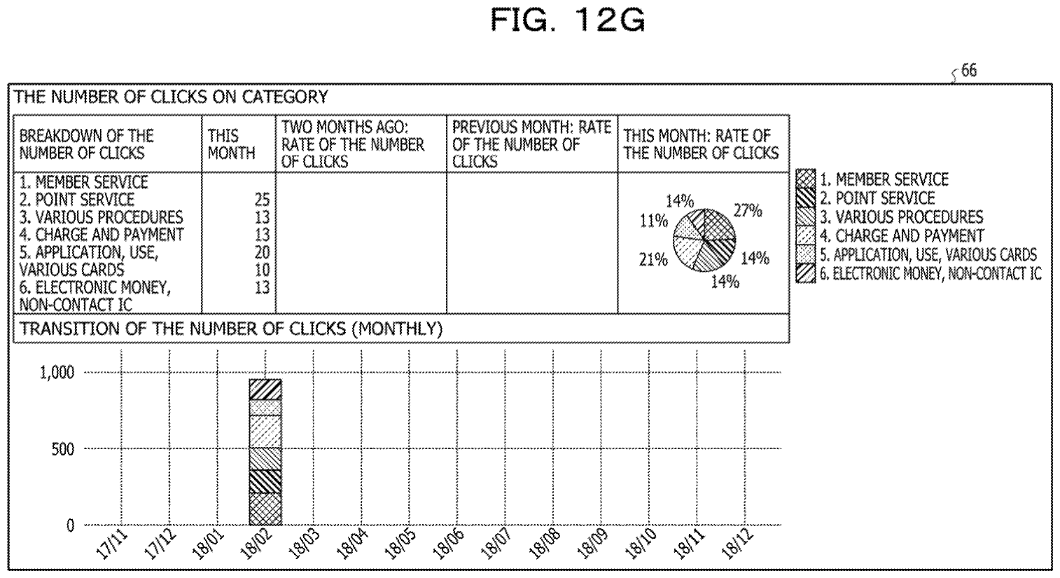

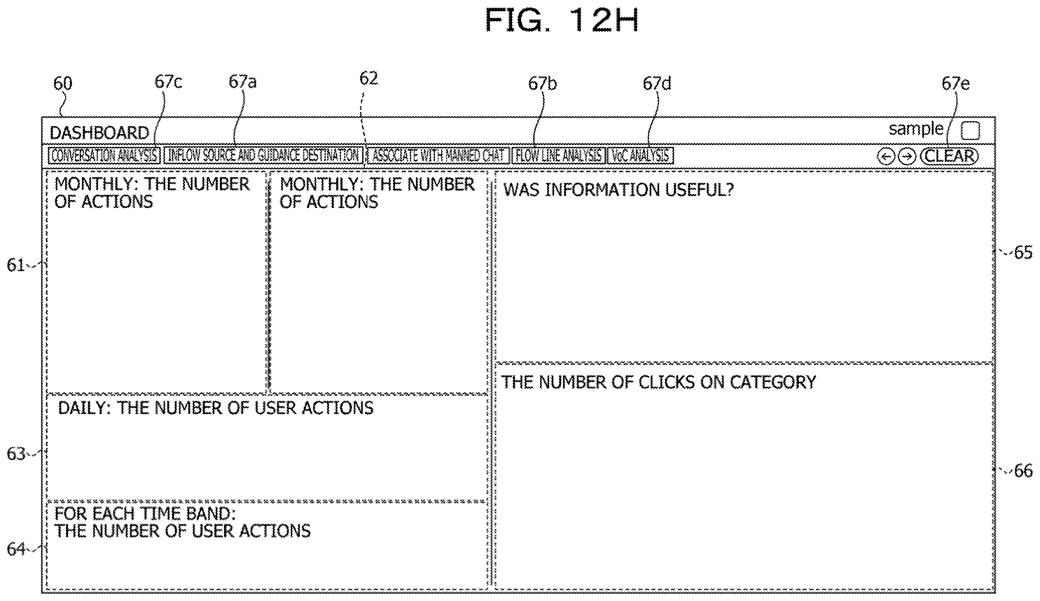

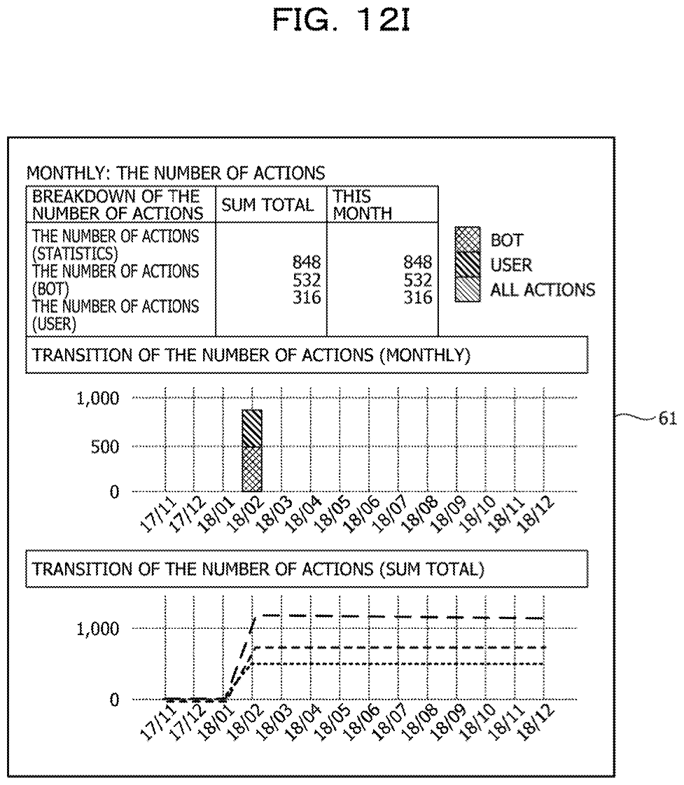

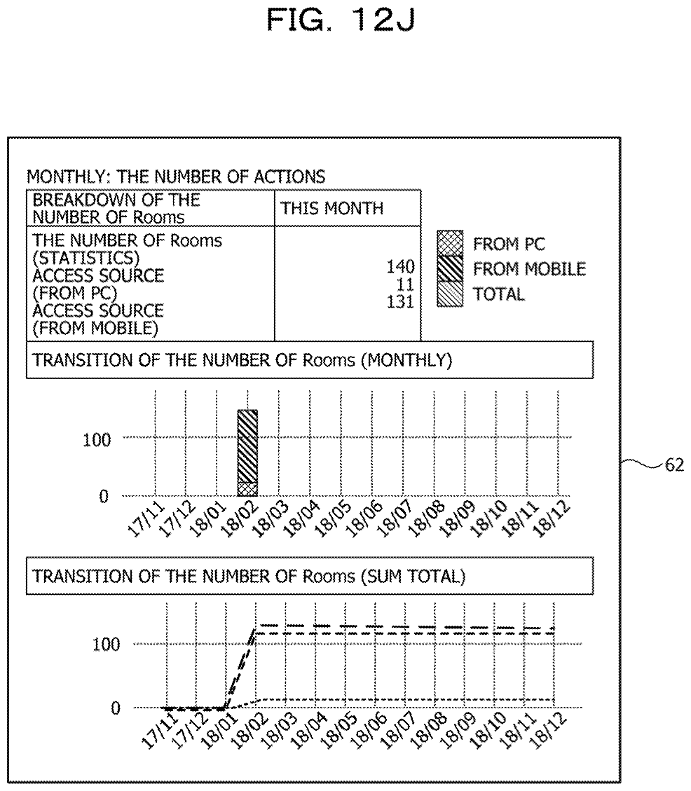

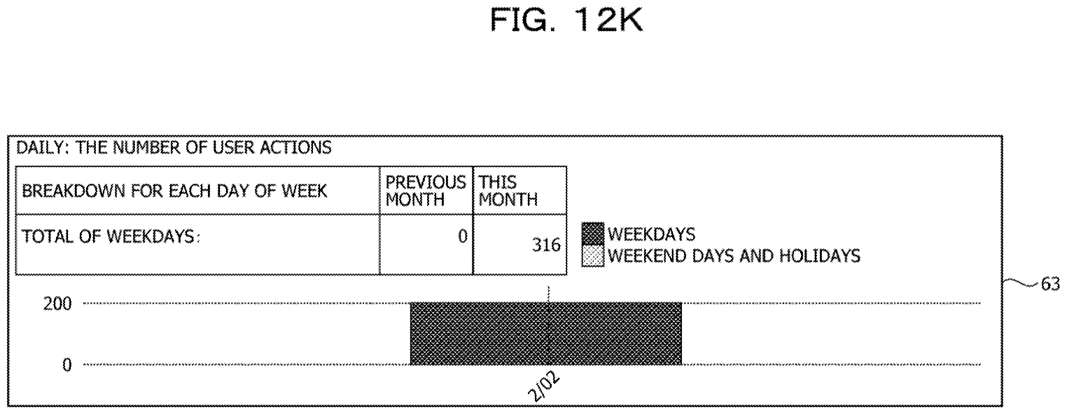

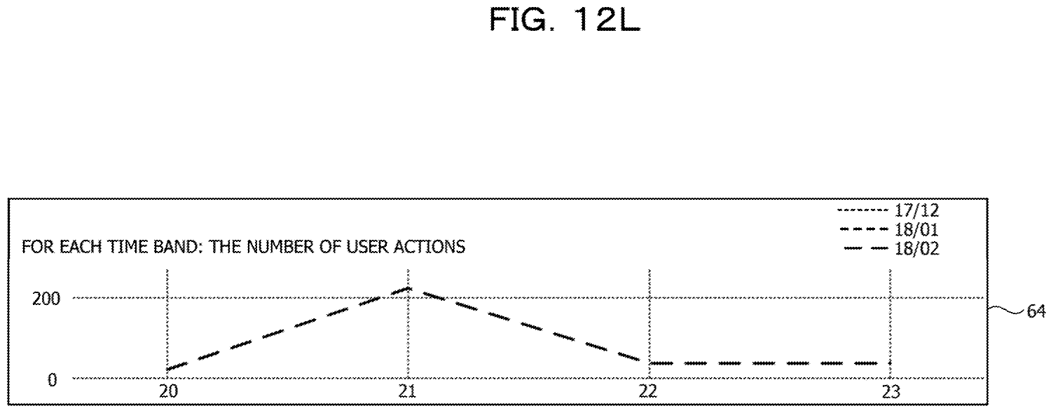

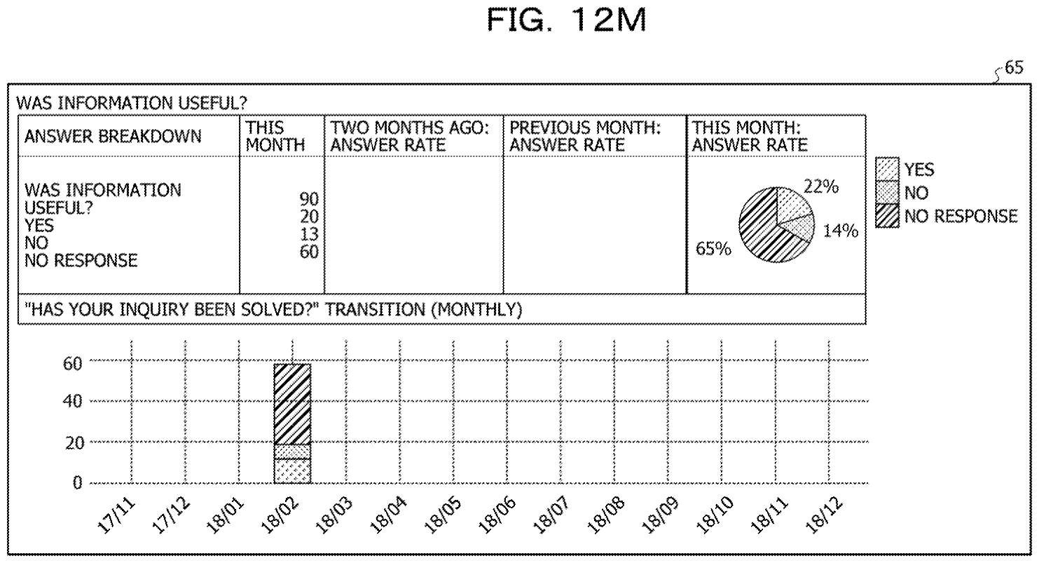

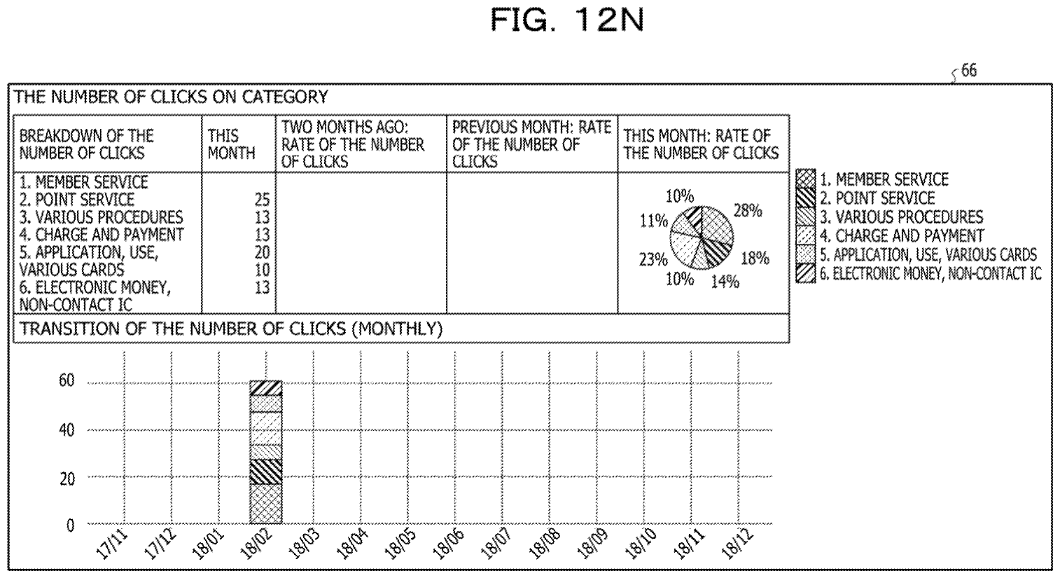

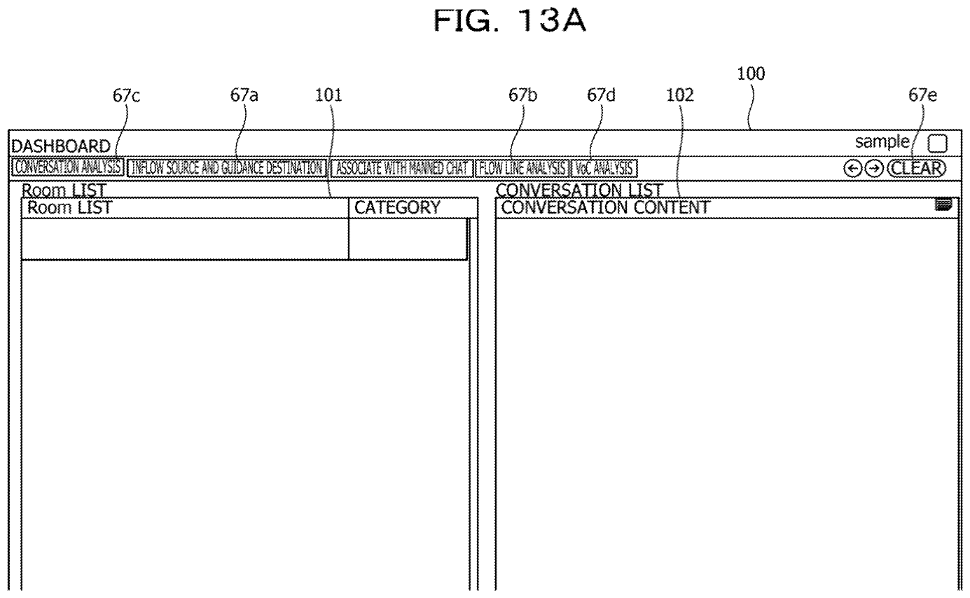

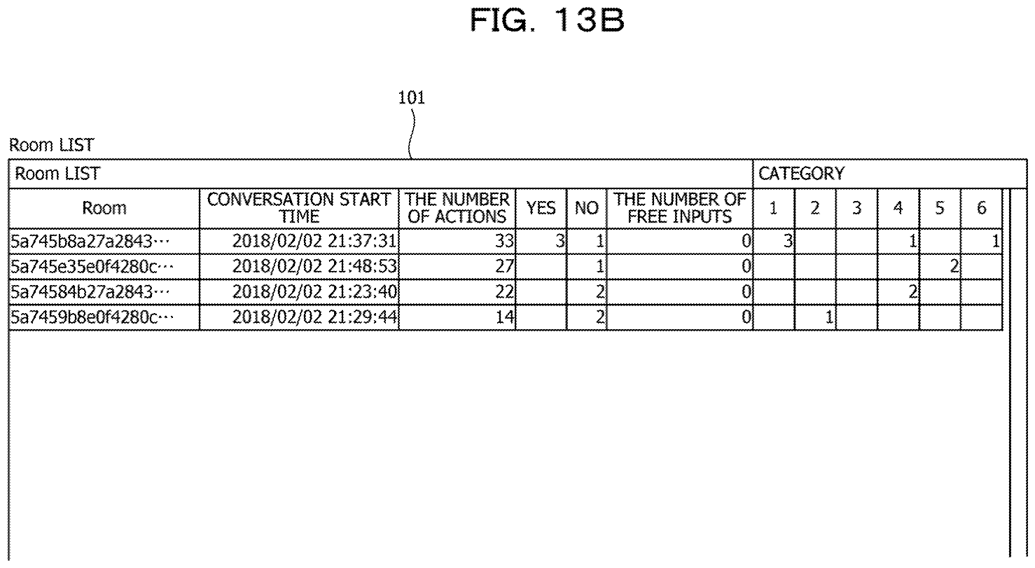

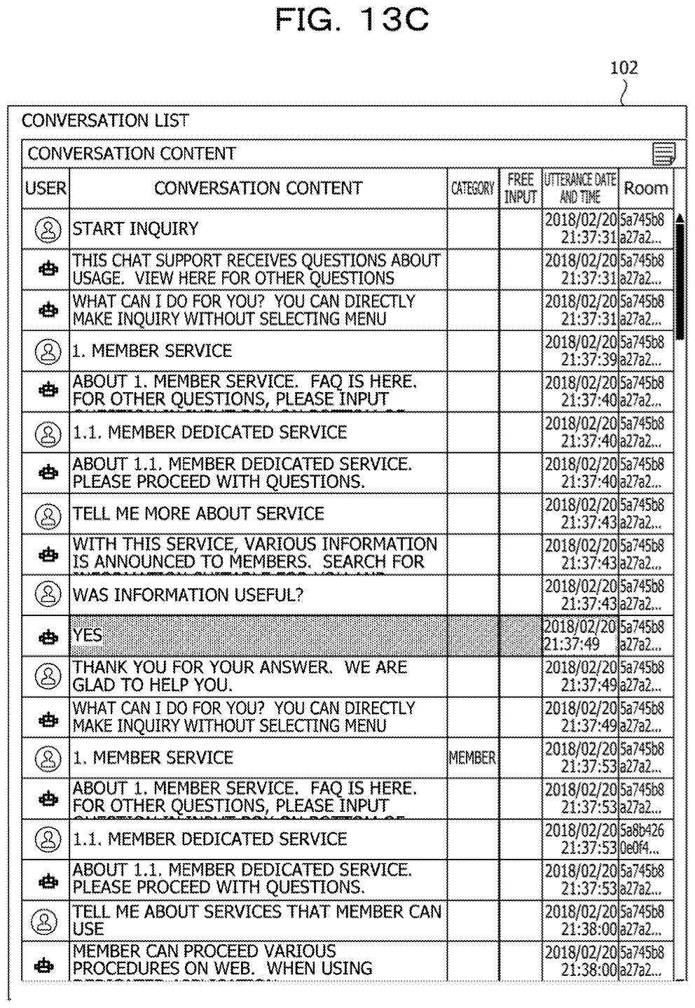

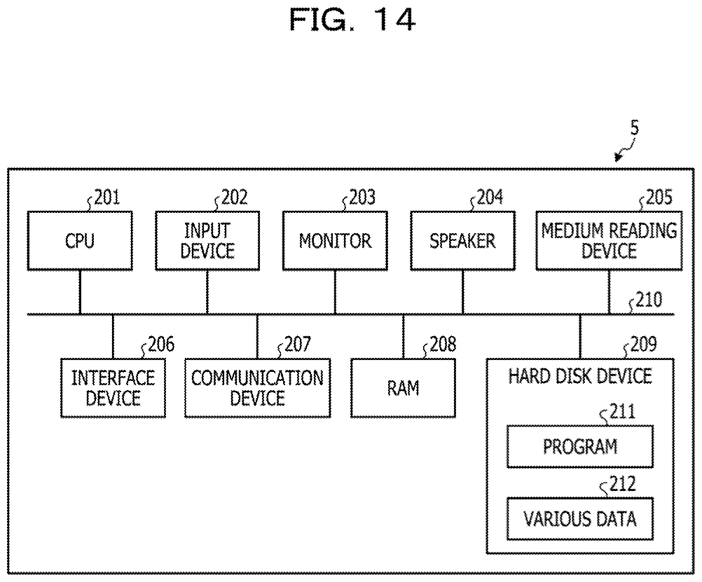

FIG. 6C is an explanatory diagram illustrating an example of a daily user action number area;

FIG. 6D is an explanatory diagram illustrating an example of an action number area for each time band;

FIG. 6E is an explanatory diagram illustrating an example of a benefit degree area;

FIG. 6F is an explanatory diagram illustrating n example of an interest-field area;

FIGS. 7A to 7D are an explanatory diagram illustrating an example of an inflow source and guidance destination analysis screen;

FIG. 8 is an explanatory diagram illustrating an example of a flow line analysis screen;

FIG. 9A is an explanatory diagram illustrating an example of a conversation analysis screen;

FIGS. 98 to 9F are an explanatory diagram illustrating an example of a VoC analysis screen;

FIG. 10A is an explanatory diagram illustrating an example of a Room list area;

FIG. 106 is an explanatory diagram illustrating an example of a detailed conversation area;

FIGS. 11A to 11G are an explanatory diagram for explaining an example of a dashboard screen after narrowing down is performed;

FIG. 12A is an explanatory diagram for explaining a case where narrowing down is further performed;

FIGS. 12B to 12N are an explanatory diagram for explaining a case where narrowing down is further performed;

FIGS. 13A to 13C are an explanatory diagram illustrating an example of a conversation analysis screen after narrowing down is performed; and

FIG. 14 is a block diagram illustrating an example of a hardware configuration of the analyzer according to the embodiment.

### DESCRIPTION OF EMBODIMENTS

As a typical technique that analyzes the collected information, there is a known analysis data management device that efficiently performs a work for confirming a large number of analysis results obtained by batch processing or the like by displaying a list of chromatograms indicating a plurality of analysis results and waveform images of spectra.

However, in the above-mentioned related art, an entire situation of inquiry response by the FAQ system is easily grasped from the information displayed in the list. However, there is a problem in that it is difficult to verify a response situation from various aspects.

In one aspect, an analysis program, an analysis method, and an analyzer that can support an operation for verifying a customer response may be provided.

Hereinafter, an analysis program, an analysis method, and an analyzer according to an embodiment will be described with reference to the drawings. The configurations having the same functions in the embodiment are denoted by the same reference signs, and the redundant description will be omitted. Note that the analysis program, the analysis method, and the analyzer described in the embodiment below are merely examples and do not limit the embodiment. Furthermore, each embodiment below may be appropriately combined within the scope of no contradiction.

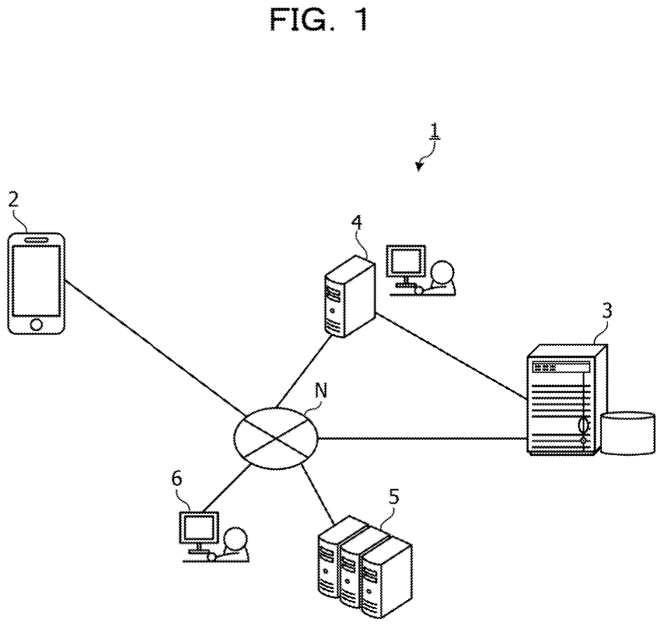

FIG. 1 is a block diagram illustrating an example of a configuration of an FAQ system. As illustrated in FIG. 1, an FAQ system 1 is a system that answers inquiries, in a chat format, that have been received from a plurality of terminals 2 of each customer via a communication network N such as the Internet.

Any type of communication network such as a Local Area Network (LAN) and a Virtual Private Network (VPN) as well as the Internet can be adopted for the communication network. N regardless of whether the network is wired or wireless.

Response methods in the chat formats of the FAQ system 1 include a manned chat in which an operator responds and an unmanned chat in which a chatbot responds by an automatic conversation program. In the present embodiment, a format that proceeds a chat by inputting a text or by an input such as a selection operation is exemplified in addition to the manned chat and the unmanned chat. However, the inquiry or the answer may be made by voice.

The terminal 2 is a terminal device that is owned by a customer who uses the FAQ system 1 and is, for example, a smartphone, a tablet terminal, a personal computer (PC), or the like. The terminal 2 accesses the chat provided by the FAQ system 1 by using, for example, a browser, a dedicated application, or the like.

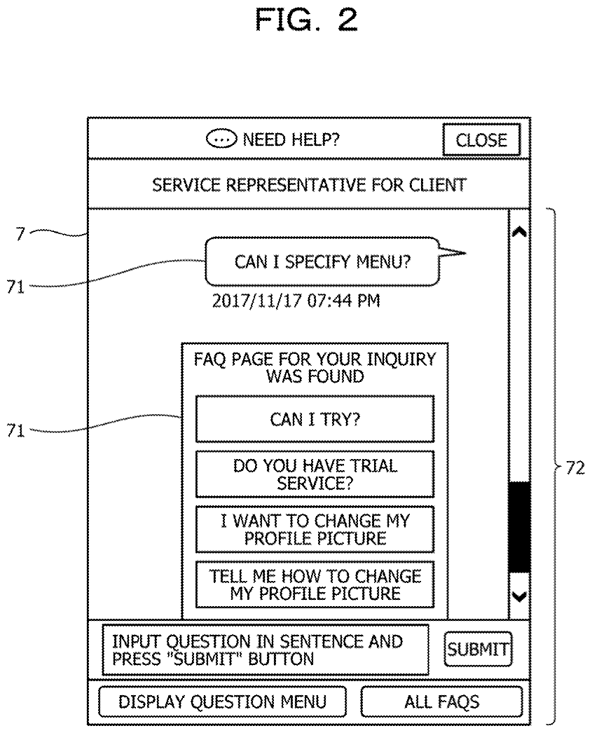

FIG. 2 is an explanatory diagram illustrating an example of a chat screen. As illustrated in FIG. 2, a chat screen 7 is a display screen on which actions 71 regarding inquiries and answers are advanced in a chat format. On the terminal 2, the chat screen 7 is displayed by accessing the FAQ system 1.

The action 71 is an utterance of a user of the terminal 2 or an answerer (operator in a case of manned chat, chatbot in a case of unmanned chat). The action 71 includes selection made by a clicking operation, text input, or the like and is displayed, for example, in a balloon format. The series of actions 71 made by accessing the FAQ system 1 is managed as a conversation (Room) 72. For example, the conversation (Room) 72 is a group from start of the chat to end of the chat as a single unit.

The FAQ system 1 activates a conversation (Room) 72 to which unique identification information (Room ID or the like) is assigned by the access from the terminal 2. Then, the FAQ system 1 manages a history of each of the actions 71 in the conversation (Room) 72 in association with the identification information of the conversation (Room) 72 as a log of the conversation (Room) 72. Information managed as the log of the conversation (Room) 72 includes, for example, selection and input content related to an inquiry or an answer.

Furthermore, the information managed as the log includes information regarding the conversation (Room) 72 at start or end of the chat. For instance, the information at the start of the chat includes information regarding a chat start time and an entrance to a chat service of the FAQ system 1 (inflow source). For example, the information regarding the inflow source includes information indicating a link source when there is an access from the terminal 2 via a link such as a homepage, a Social Networking Service (SNS), or the like, information indicating the terminal 2 such as a PC or a mobile, or the like.

Furthermore, the information at the time of the end of the chat includes information regarding a chat end time, a guidance destination to which an answer is guided, a chat end state, or the like. The information indicating the guidance destination includes guidance from an unmanned chat to a manned chat, guidance to an external system (homepage or the like), or the like. Furthermore, the information indicating the chat end state includes access disconnection from the terminal 2, end by the guidance to the guidance destination, normal end, or the like.

Returning to FIG. 1, the FAQ system 1 includes a host computer 3, a monitoring device 4, an analyzer 5, and an analysis terminal 6. These devices are communicably connected to each other via the communication network N or the like.

The host computer 3 is a server device that provides the chat service in the FAQ system 1. The host computer 3 activates the conversation (Room) 72, to which the unique identification information (Room ID or the like) is assigned, in response to the access from the terminal 2, and starts a chat service by the chatbot. Furthermore, the host computer 3 records a log of the unmanned chat in the conversation (Room) 72 when the chat service starts. Furthermore, in a case where connection to a manned chat is instructed in the action 71 from the terminal 2, the host computer 3 instructs the monitoring device 4 to start the manned chat in the conversation (Room) 72 together with the identification information of the conversation (Room) 72.

The monitoring device 4 is a terminal device of an operator who is in charge of the manned chat. In a case where the host computer 3 instructs to start the manned chat together with the identification information of the conversation (Room) 72, the monitoring device 4 performs the manned chat in the conversation (Room) 72 by presenting a screen similar to the chat screen 7 to the operator. Furthermore, the monitoring device 4 records a log of the manned chat in the conversation (Room) 72 when the manned chat starts.

With these operations, the FAQ system 1 can respond by using the unmanned chat by the chatbot of the host computer 3, and subsequently, the manned chat by the monitoring device 4. Furthermore, the logs of the unmanned chat and the manned chat in the conversation (Room) 72 are respectively managed by the host computer 3 and the monitoring device 4 in association with the identification information of the conversation (Room) 72.

The analyzer 5 is an information processing device that collects the logs managed by the host computer 3 and the monitoring device 4 and analyzes inquiry content received and collected from the plurality of terminals 2 on the basis of various indexes that have been set in advance. For example, the index to be analyzed includes the inflow source to the chat and the guidance destination, detailed breakdown of the action 71, processing times in the unmanned chat and the manned chat, or the like.

The analysis terminal 6 is a terminal device that is used by an analyzer (user) who analyzes the information collected through the response to the customer by the FAQ system. The analysis terminal 6 sends an instruction to perform analysis received from the user to the analyzer 5 and receives display data of the analysis result from the analyzer 5 and displays the data, With this operation, the user can analyze the information collected through the response to the customer by the FAQ system 1.

Note that, in the following description, in a case where the user of the terminal 2 is distinguished from the user of the analysis terminal 6, the user of the terminal 2 is referred to as a user (customer), and the user of the analysis terminal 6 is referred to as a user (analyzer).

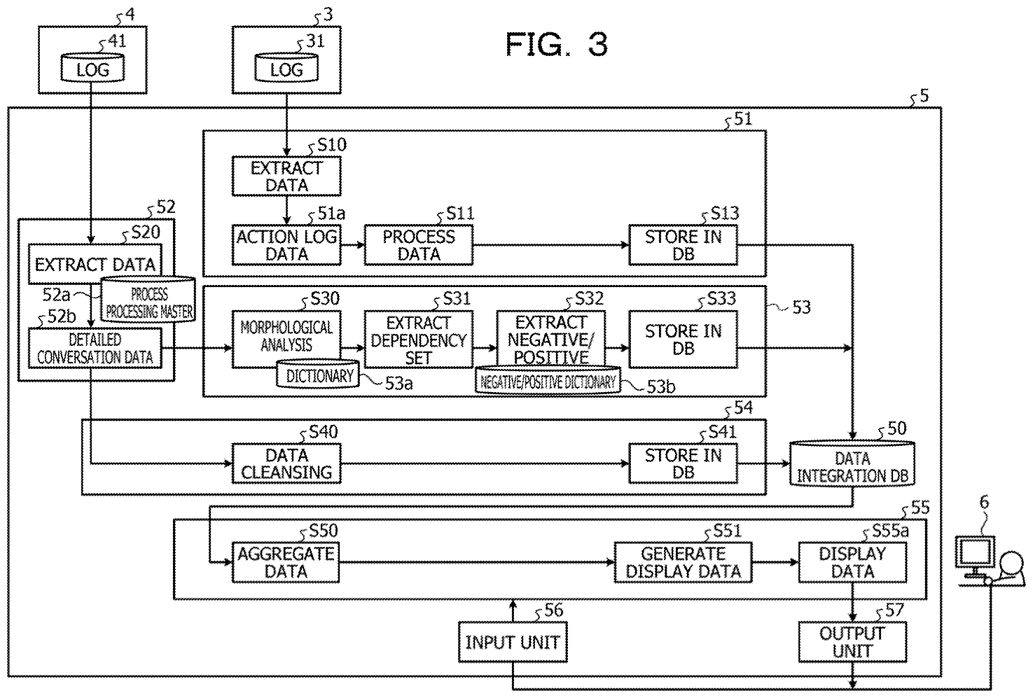

FIG. 3 is a block diagram illustrating an exemplary functional configuration of the analyzer 5 according to the embodiment. As illustrated in FIG. 3, the analyzer 5 includes a data integration DB 50, a bot data analysis unit 51, a conversation extraction unit 52, a conversation analysis unit 53, a cleansing unit 54, a display processing unit 55, an input unit 56, and an output unit 57.

The data integration DB 50 is a database that manages analysis results obtained by collecting logs 31 and 41 of the host computer 3 and the monitoring device 4 and analyzing each conversation (Room) 72 via the bot data analysis unit 51, the conversation extraction unit 52, the conversation analysis unit 53, and the cleansing unit 54. For instance, the data integration DB 50 stores inquiry content in the conversation (Room) 72 analyzed on the basis of a plurality of indexes that has been set in advance and includes an inflow source of the inquiry and a guidance destination of the inquiry. For example, the data integration DB 50 is an example of a storage unit.

The index to be analyzed is appropriately set by the user and includes, for example, a date and time of the chat, the inflow source and the guidance destination of the chat, the detailed breakdown of the action 71, the processing times in the unmanned chat and the manned chat, or the like. Furthermore, regarding conversation content in the conversation (Room) 72, the number of answers including a predetermined option (Yes/No, or the like), the number of appearances of a predetermined keyword in the conversation content, dependency analysis using a keyword, negative/positive analysis using the keyword, or the like may be used as an index.

The bot data analysis unit 51 analyzes content of the action 71 (bot data) of the unmanned chat in the conversation (Room) 72 from the log 31 of the host computer 3 on the basis of a predetermined index and stores the analysis result in the data integration DB 50. For instance, the bot data analysis unit 51 extracts data for each conversation (Room) 72 from the log 31 on the basis of the identification information (Room ID or the like) (S10).

Next, the bot data analysis unit 51 performs data processing, such as arranging data in chronological order, on extracted action log data 51a, and then, performs analysis for each index such as the date and time of the chat, the inflow source and the guidance destination of the chat, the processing time from start to end, or the like (S11). At this time, the bot data analysis unit 51 compares the action log data 51a arranged in chronological order with a talk script in which the action 71 of the chatbot is determined. With this operation, the bot data analysis unit 51 analyzes (flow line analysis) along which scenario (flow line) a dialogue of the unmanned chat is proceeded in an inquiry flow based on the talk script. Next, the bot data analysis unit 51 stores the analysis result in the data integration DB 50 together with the identification information of the conversation (Room) 72 (S13).

The conversation extraction unit 52 extracts conversation content of the manned chat in the conversation (Room) 72 from the log 41 of the monitoring device 4. For instance, the conversation extraction unit 52 extracts data for each conversation (Room) 72 from the log 41 on the basis of the identification information (Room ID or the like). Next, the conversation extraction unit 52 refers a predetermined process processing master 52a for extraction of a conversation part and extracts detailed conversation data 52b indicating details of the conversation in the manned chat in the conversation (Room) 72 (conversation content of which text is input or the like) (S20).

The conversation analysis unit 53 analyzes the conversation content in the manned chat on the basis of a predetermined index on the basis of the detailed conversation data 52b extracted from the conversation (Room) 72 and stores the analysis result in the data integration DB 50.

For instance, the conversation analysis unit 53 performs morphological analysis on the detailed conversation data 52b with reference to a dictionary 53a regarding natural language processing (530) and extracts predetermined keywords that appear in the conversation content. Furthermore, the conversation analysis unit 53 extracts a dependency set that is a combination of the predetermined keywords on the basis of the extracted keywords (S31). For instance, the conversation analysis unit 53 extracts a combination of keywords such as “high”/“cheap” related to “price”.

Furthermore, the conversation analysis unit 53 extracts whether the conversation content is negative (negative) or positive (positive) on the basis of the extracted dependency set (S32). For instance, the conversation analysis unit 53 evaluates negative or positive of the conversation content on the basis of the combination of the keywords and a negative/positive dictionary 53b indicating negative/positive evaluation of combinations. For example, conversation content such as “price is high” is evaluated as negative conversation content on the basis of a combination of “price” and “high”. conversely, conversation content such as “price is cheap” is evaluated as positive conversation content on the basis of a combination of “price” and “cheap”.

Next, the conversation analysis unit 53 stores the extracted keyword, the dependency set, the negative/positive evaluations, or the like in the data integration DB 50 as the analysis results, together with the identification information of the conversation (Room) 72 (S33).

The cleansing unit 54 analyzes the detailed conversation data 52b extracted from the conversation (Room) 72 on the basis of the indexes such as the processing time of the conversation in the manned chat, the number of selections of Yes/No, or the like and stores the analysis result in the data integration DB 50. For instance, the cleansing unit 54 performs data cleansing on the detailed conversation data 52b (S40) and extracts information such as a processing time from start to end of the conversation, the number of times of selection of the predetermined option, the number of clicks, or the like. Next, the cleansing unit 54 stores the extracted information in the data integration DB 50 as the analysis result, together with the identification information of the conversation (Room) 72 (S41).

The display processing unit 55 collects data from the data integration DB 50 in response to an instruction of the user received from the analysis terminal 6 via the input unit 56 (S50) and generates display data 55a that displays an analysis result of the inquiry content received and collected from the terminal 2 (S51). Next, the display processing unit 55 displays the analysis result corresponding to the instruction of the user on the analysis terminal 6 by outputting the generated display data 55a to the analysis terminal 6 via the output unit 57.

For instance, in a case where the display processing unit 55 receives an instruction to display a dashboard screen that displays a list of the analysis results of the inquiry content received and collected from the terminal 2, the display processing unit 55 collects the analysis result obtained by referring to the data integration DB 50 and analyzing each conversation (Room) 72 on the basis of the plurality of indexes. Next, the display processing unit 55 obtains a total value obtained by performing addition under a predetermined condition such as monthly, daily, each time band, or the like on the basis of the collected analysis results. Then, the display processing unit 55 generates the display data 55a, on the basis of the obtained total value, in which the total value or a graph corresponding to the total value (pie chart, bar chart, line chart, or the like) is arranged according to a display format of the dashboard screen.

By outputting the generated display data 55a to the analysis terminal 6, the dashboard screen that displays the list of the analysis results is displayed on the analysis terminal 6. By referring to the dashboard screen displayed on the analysis terminal 6, the user can easily analyze the entire response to the customer by the FAQ system 1.

Furthermore, in a case where the display processing unit 55 receives narrowing down of the analysis relative to any one of a plurality of analysis results from the analysis terminal 6 via the input unit 56, the display processing unit 55 narrows down the analysis results and also narrows down the other analysis results displayed in the list and displays a list of the plurality of analysis results that has been narrowed down.

For instance, the display processing unit 55 accepts specification of the narrowing condition by operating a button on a dashboard screen 60, selecting an element (for example, inflow source, guidance destination, date, time band, answer content (Yes/No), or the like) included in the analysis result, or the like. For example, in a case where a predetermined date is selected from among dates in a certain analysis result of the plurality of analysis results displayed as the list on the dashboard screen 60, the display processing unit 55 accepts the selected date and the narrowing condition.

Next, the display processing unit 55 performs data aggregation on the analysis result that has received the narrowing condition under the narrowing condition. Similarly, the display processing unit 55 performs data aggregation on the other analysis results displayed in the list under the same narrowing condition. Next, the display processing unit 55 generates the display data 55a that displays the plurality of analysis results aggregated under the accepted narrowing condition on the basis of the result of the data aggregation.

By outputting the display data 55a to the analysis terminal 6, the analysis terminal 6 displays a list of the plurality of analysis results obtained by narrowing down the analysis on any one of the plurality of analysis results and narrowing down the other analysis results. Therefore, the user can easily verify a response situation from various aspects and can easily verify the response to the customer.

The input unit 56 receives an instruction of the user from the analysis terminal 6 by communication via the communication network N and outputs the received instruction to the display processing unit 55. The output unit 57 transmits the display data 55a generated by the display processing unit 55 to the analysis terminal 6 by the communication via the communication network N.

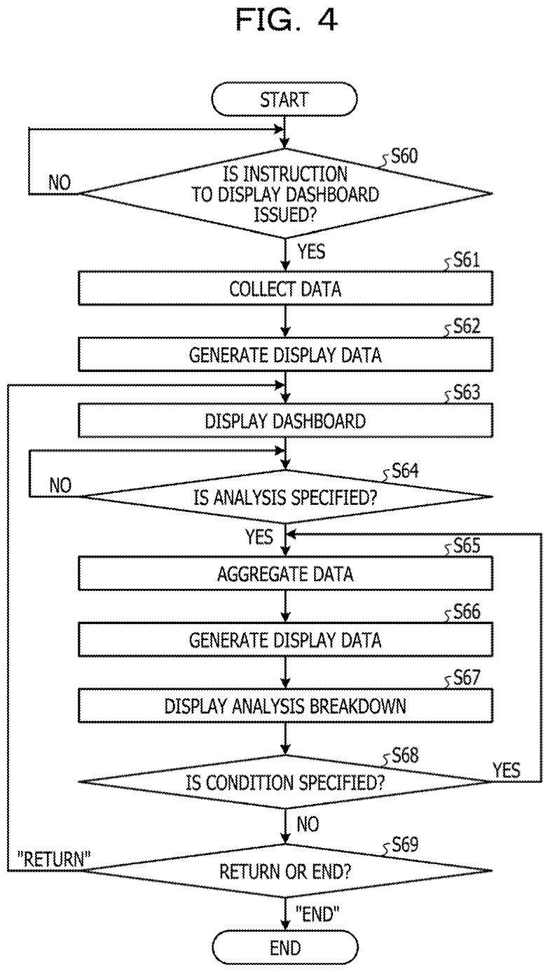

FIG. 4 is a flowchart illustrating an exemplary operation of the analyzer 5 according to the embodiment. As illustrated in FIG. 4, when processing is started, the display processing unit 55 determines whether or not an instruction to display the dashboard screen is issued on the basis of the instruction from the analysis terminal 6 (560) and stands by processing in a case where the display instruction is not issued (560: NO).

In a case where the display instruction is issued (560: YES), the display processing unit 55 refers to the data integration DB 50 and collects the data regarding each conversation (Room) 72 analyzed on the basis of the plurality of indexes (561).

Next, the display processing unit 55 obtains a total value obtained by performing addition under a predetermined condition such as monthly, daily, each time band, or the like on the basis of the collected data and generates the display data 55a on the dashboard screen that displays a graph corresponding to the total value or the like (S62). Next, the display processing unit 55 outputs the display data 55a to the analysis terminal 6 via the output unit 57, and the analysis terminal 6 displays the dashboard screen on the basis of the display data 55a (563).

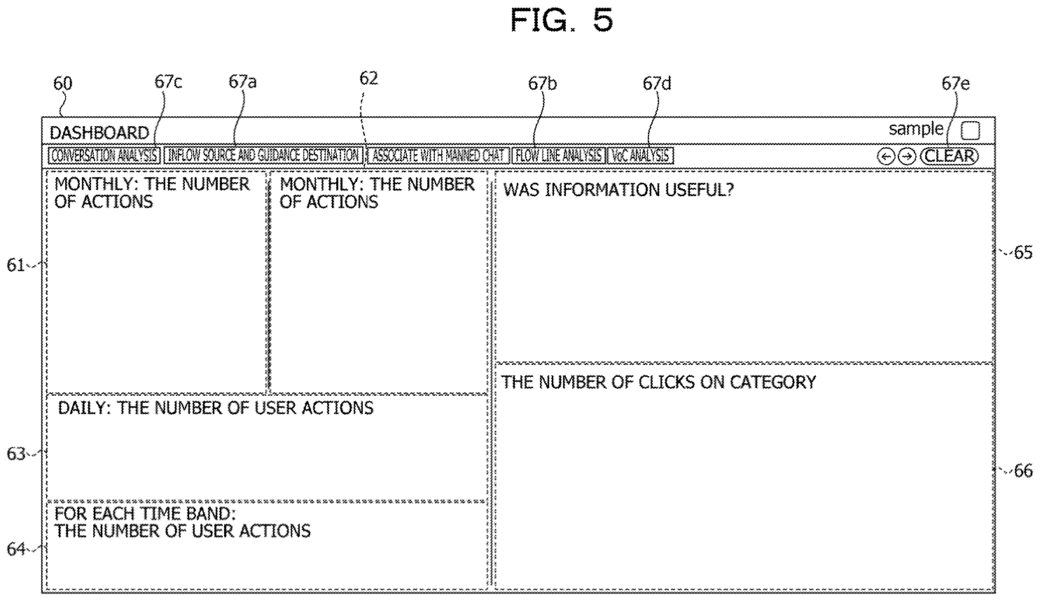

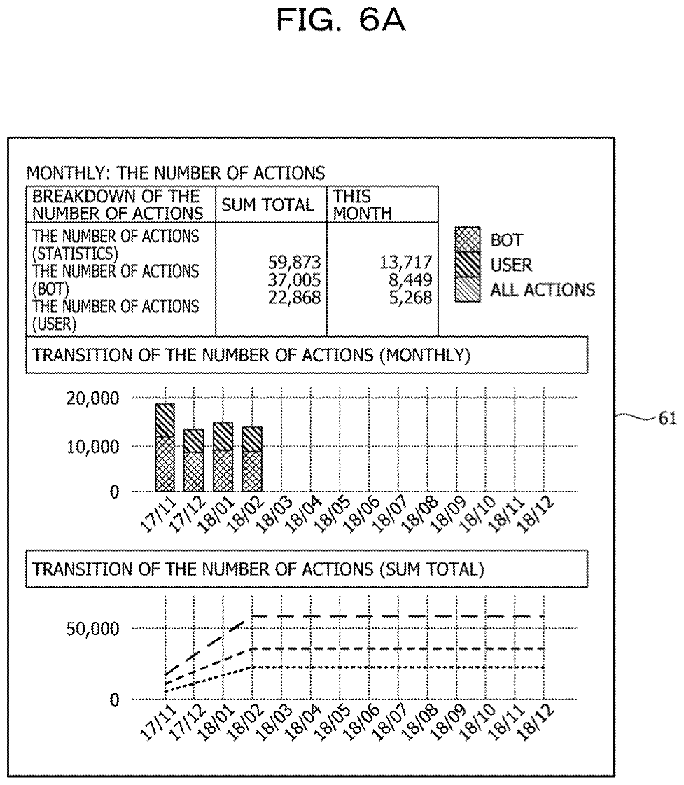

FIG. 5 is an explanatory diagram illustrating an example of a dashboard screen. As illustrated in FIG. 5, the dashboard screen 60 includes an action number area 61, a Room number area 62, a daily user action number area 63, an action number area for each time band 64, a benefit degree area 65, and an interest-field area 66. Furthermore, the dashboard screen 60 includes buttons 67a to 67e that receive operations from the user. The dashboard screen 60 displays a list of analysis results of the inquiry content received and collected from the terminal 2 in each area.

FIG. 6A is an explanatory diagram illustrating an example of the action number area 61. As illustrated in FIG. 6A, the action number area 61 is an area that displays the number of actions 71 counted for each month. For instance, in the action number area 61, a total value of an index in breakdown, transition, a sum total or the like of the number of actions for each month or a graph corresponding to the total value is displayed. From the action number area 61, the user can confirm the breakdown, the transition, and the sum total of the number of actions for each month. Note that “total” or “all actions” indicate the total value of number of actions in the manned chat and the unmanned chat. “Bot” is a total value of the number of actions in the unmanned chat. “User” is a total value of the number of actions in the manned chat.

FIG. 6B is an explanatory diagram illustrating an example of the Room number area 62. As illustrated in FIG. 6B, the Room number area 62 is an area that displays the number of conversations (Room) 72 counted for each month. For instance, in the Room number area 62, a total value of an index in breakdown, transition, a sum total or the like of the number of Rooms for each month or a graph corresponding to the total value is displayed. From the Room number area 62, the user can confirm the breakdown, the transition, and the sum total of the number of Rooms for each month. Note that “total” is a total value of the number of Rooms activated from all the terminals 2. “From PC” is a total value of the number of Rooms activated from the terminal 2 of which an inflow source is a PC. “From mobile” is a total value of the number of Rooms activated from the terminal 2 of which an inflow source is a mobile terminal such as a smartphone.

FIG. 6C is an explanatory diagram illustrating an example of the daily user action number area 63. As illustrated in FIG. 6C, the daily user action number area 63 is an area that displays the number of user actions (number of utterances) for each day. From the daily user action number area 63, the user can grasp a transition of the number of utterances for each day (weekday, holiday, or the like).

FIG. 6D is an explanatory diagram illustrating an example of the action number area for each time band 64. As illustrated in FIG. 6D, the action number area for each time band 64 is an area that displays the number of user actions (the number of utterances) for each time band. From the action number area for each time band 64, the user can grasp a transition of the number of utterances for each time band (daytime, nighttime, or the like).

FIG. 6E is an explanatory diagram illustrating an example of the benefit degree area 65. As illustrated in FIG. 6E, the benefit degree area 65 is an area that indicates an index used to evaluate a benefit degree of the customer. For instance, in the benefit degree area 65, total values of the number of displayed cases that request an answer regarding satisfaction such as “Has your inquiry been solved?” and the number of answers with respect to the satisfaction (the number of “Yes”/“No”) or a graph corresponding to the total value in the action 71 are displayed. From the benefit degree area 65, the user can confirm the benefit degree of the customer regarding services provided by the FAQ system 1.

FIG. 6F is an explanatory diagram illustrating an example of the interest-field area 66. As illustrated in FIG. 6F, the interest-field area 66 is an area that indicates an index used to evaluate a field of an interest of the customer. For instance, in the interest-field area 66, a total value of the number of clicks on a category in which the customer is interested in the action 71 or a graph corresponding to the total value is displayed. From the interest-field area 66, the user can confirm the field of interest of the customer.

Note that, in each area of the dashboard screen 60, the element (for example, inflow source, guidance destination, date, time band, answer content (Yes/No), or the like) included in the analysis result can be selected as the narrowing condition by using a hyperlink or the like.

The buttons 67a to 67d are buttons that instruct to switch the content of the displayed list on the dashboard screen 60. The button 67e is a button used to instruct to cancel narrowed-down display under a predetermined condition.

The displayed list of the plurality of analysis results on the dashboard screen 60 may be switched on the basis of the operations on the buttons 67a to 67d. For instance, the display processing unit 55 recollects analysis results corresponding to display content after switching from the data integration DB 50 in response to the operations on the buttons 67a to 67d and generates display data 55a on the basis of the recollected analysis results. Next, the display processing unit 55 outputs the display data 55a to the analysis terminal 6 via the output unit 57, and the analysis terminal 6 makes a display on the basis of the display data 55a.

For example, the button 67a is a button used to instruct switching to an inflow source and guidance destination analysis screen that displays details of analysis content regarding the inflow source and the guidance destination among the plurality of analysis results. The button 67b is a button used to instruct switching to a flow line analysis screen that displays details of content of flow line analysis among the plurality of analysis results. The button 67c is a button used to instruct switching to a conversation analysis screen that displays details of individual inquiry content (conversation) among the plurality of analysis results. The button 57d is a button used to instruct switching to a VoC analysis screen that displays details of Voice of Customer (VoC) analysis among the plurality of analysis results.

FIGS. 7A to 7D are an explanatory diagram illustrating an example of the inflow source and guidance destination analysis screen. As illustrated in FIGS. 7A to 7D, an inflow source and guidance destination analysis screen 80 includes Room number transitions 81a and 81b, present month breakdowns 82a and 82b, and previous month breakdowns 83a and 83b. Each of the Room number transitions 81a and 81b is a graph illustrating a transition of the number of Rooms regarding the inflow source (from LINE, from telephone, from chatbot) and the guidance destination (to manned chat, to external system A, to external system B, complete chatbot (normal end)). The present month breakdowns 82a and 82b indicate breakdowns of the inflow sources and the guidance destinations in this month. The previous month breakdowns 83a and 83b indicate breakdowns of the inflow sources and the guidance destinations in the previous month. From the inflow source and guidance destination analysis screen 80, the user can easily grasp tendency of the inflow source to the chatbot and the guidance destination from the chatbot.

FIG. 8 is an explanatory diagram illustrating an example of a flow line analysis screen. As illustrated in FIG. 8, a flow line analysis screen 90 is a screen that superimposes and displays values obtained by counting along a flow (flow line) 91 in a talk script of a chatbot on the basis of the analysis result of the bot data analysis unit 51. From the flow line analysis screen 90, the user can confirm the analysis result along the flow of the talk script.

In the flow (flow line) 91, a leaving icon 92 is displayed at a branch from which a procedure leaves from the flow of the talk script of the chatbot, and an answer content graph 93 is displayed at a branch where an inquiry about satisfaction is made. With these icons, the user can easily identify the branch from which the procedure leaves from the unmanned chat by the chatbot and the branch where the inquiry about the satisfaction is made in the flow (flow line) 91. The leaving icon 92 may have a different shape according to the number of leaving ways at the branch (for example, increase the number of overlapped circles as the number increases). Furthermore, an answer content graph 93 may be a pie chart indicating breakdown of the branches.

FIG. 9A is an explanatory diagram illustrating an example of a conversation analysis screen. As illustrated in FIG. 9A, a conversation analysis screen 100 includes a Room list area 101 and a detailed conversation area 102.

FIG. 10A is an explanatory diagram illustrating an example of the Room list area 101. As illustrated in FIG. 10A, the Room list area 101 is an area that displays a list of the analysis results for each inquiry received from the terminal 2. For instance, in the Room list area 101, a list that includes, for example, identification information of the Room, a conversation start time, a total number of actions 71, the number of Yeses/Nos, the number of actions 71 classified into each of a predetermined category is displayed. Furthermore, for each Room in the Room list area 101, an inflow source/guidance destination icon 101a that distinguishably displays an inflow source/guidance destination may be applied. With this icon, the user can easily confirm the inflow source and the guidance destination to/from the Room in the Room list area 101.

FIG. 10B is an explanatory diagram illustrating an example of the detailed conversation area 102. As illustrated in FIG. 10B, the detailed conversation area 102 is an area that displays a list of response content in response to an inquiry for each inquiry. With this area, the user can easily confirm the response content in response to the inquiry. For example, in the detailed conversation area 102, a list of the response content of the Room selected in the Room list area 101 may be displayed. Note that the response content in the detailed conversation area 102 may be displayed in a form according to the type of the action 71 (answer of Yes/No, inflow source, guidance destination, or the like).

FIGS. 9B-9F are an explanatory diagram illustrating an example of a VoC analysis screen. As illustrated in FIGS. 9B-9F, a VoC analysis screen 110 includes a keyword appearance transition area 111 that displays a list of the analysis results by the conversation analysis unit 53 or the like, a keyword ranking area 112, a negative/positive analysis area 113, and a dependency ranking area 114. The detailed of the areas of the VoC analysis screen 110 are illustrated in FIGS. 9C-9F.

The keyword appearance transition area 111 is an area that displays a transition of appearance of a predetermined keyword included in the action 71, for example, for each date. The keyword ranking area 112 is an area that displays a ranking of the keywords included in the action 71, for example, for each date. The negative/positive analysis area 113 is an area that displays results of negative/positive analysis for each keyword, for example, for each date. The dependency ranking area 114 is an area that displays a list of rankings related to the number of appearances of a set of a predetermined word and a word having dependency with the predetermined word. By using the keyword appearance transition area 111, the keyword ranking area 112, the negative/positive analysis area 113, and the dependency ranking area 114, the user (analyzer) can easily confirm an interest of the user (customer) regarding the inquiry content and a reaction state with respect to the interest.

Returning to FIG. 4, the display processing unit 55 determines whether or not to specify analysis for narrowing down data in response to of the instruction of the user received from the analysis terminal 6 via the input unit 56 (S64). For example, in a case where an operation for selecting a predetermined element or the like is performed on the dashboard screen 60, the display processing unit 55 assumes that the analysis that uses the selected element as a narrowing condition is specified.

In a case where the analysis is not specified (S64: NO), the display processing unit 55 stands by processing. In a case where the analysis is specified (S64: YES), the display processing unit 55 performs data aggregation under the narrowing condition on the analysis result in each area (S65) and generates the display data 55a that displays the reaggregated analysis result (S66). By outputting the display data 55a to the analysis terminal 6, on the display screen of the analysis terminal 6 (dashboard screen 60, inflow source and guidance destination analysis screen 80, flow line analysis screen 90, conversation analysis screen 100, and VoC analysis screen 110), analysis breakdown after narrowing down is performed is displayed (567).

FIGS. 11A to 11G are an explanatory diagram for explaining an example of the dashboard screen 60 after narrowing down is performed. Note that it is assumed that “18/02” be selected in the action number area 61 as a narrowing condition for the month. As illustrated in FIGS. 11A to 11G, by selecting “18/02” in the action number area 61, the narrowed-down results corresponding to “18/02” are displayed in the action number area 61. Furthermore, similarly, in the Room number area 62, the daily user action number area 63, the action number area for each time band 64, the benefit degree area 65, and the benefit degree area 65, results are narrowed down to the analysis results corresponding to “18/02”. With this operation, the user can verify a response situation from various aspects in a state where the analysis results are narrowed down to the analysis results corresponding to “18/02”.

Subsequently, the display processing unit 55 determines whether or not a narrowing condition is further specified by an operation for selecting a predetermined element or the like (S68). In a case where the narrowing condition is further specified (S68: YES), the display processing unit 55 returns the processing to S65 and performs display under the further specified narrowing condition.

FIGS. 12-1 and 12-2 are explanatory diagrams for explaining a case where narrowing down is further performed. Note that, as in FIGS. 11A to 11G, it is assumed that the month is narrowed down with “18/02” on the dashboard screen 60 in FIG. 12A. As illustrated in FIG. 12A, in the action number area for each time band 64, selection and specification 64a of the narrowing condition is further performed. For instance, by performing the selection and specification 64a, a predetermined time band (19:30 to 23:00 in illustrated example) is specified as the narrowing condition.

As illustrated in FIGS. 12B to 12N, by performing the selection and specification 64a in the action number area for each time band 64, the analysis result in each area on the dashboard screen 60 is narrowed down to the results corresponding to the specified condition (time band of 19:30 to 23:00) and displayed. In this way, by further performing narrowing down, the user can verify more detailed response situation.

FIGS. 13A to 13C are an explanatory diagram illustrating an example of the conversation analysis screen 100 after narrowing down is performed. In a case where, for example, the button 67c is operated on the dashboard screen 60 after narrowing down is performed illustrated in FIGS. 12B to 12N, the conversation analysis screen 100 in which narrowing down is performed under the same condition may be displayed as illustrated in FIGS. 13A to 13C. Note that, in a case where the buttons 67a, 67b, and 67d are operated, similarly, the inflow source and guidance destination analysis screen 80, the flow line analysis screen 90, and the VoC analysis screen 110 in which narrowing down is performed may be displayed. With this display, the user can verify more detailed response situations from various aspects.

In a case where the narrowing condition is not specified (S68: NO), the display processing unit 55 determines to return to the dashboard screen 60 on which narrowed-down display is canceled or to end the processing in response to the instruction of the user received from the analysis terminal 6 via the input unit 56 (569). For instance, in a case where the button 67e is operated, the display processing unit 55 assumes that an instruction to cancel the narrowed-down display or the like is issued and returns the processing to S63. Furthermore, the display processing unit 55 ends the processing in a case where an instruction to end the dashboard screen 60, or the like, is issued.

As described above, the analyzer 5 includes the input unit 56 and the display processing unit 55. The input unit 56 receives an instruction input of the user via the analysis terminal 6 or the like. In a case of receiving an instruction to display the inquiry content received and collected from the plurality of terminals 2, the display processing unit 55 displays a list of a plurality of analysis results obtained by referring to the data integration DB 50 and analyzing the inquiry content on the basis of a plurality of indexes on the dashboard screen 60. The data integration DB 50 stores inquiry content analyzed on the basis of a plurality of indexes including an inflow source of the inquiry and a guidance destination of the inquiry. In a case of accepting to narrow down the analysis with respect to any one of the plurality of analysis results of which the list is displayed on the dashboard screen 60, the display processing unit 55 narrows down the analysis results and also narrows down other analysis results displayed in the list. Next, the data integration DB 50 displays a list of the plurality of analysis results which has been narrowed down on the dashboard screen 60.

From the dashboard screen 60, the user can confirm the list of the plurality of analysis results obtained by narrowing down any one of the plurality of analysis results and narrowing down the other analysis results. Therefore, the response situation can be verified from various aspects easily, and it is possible to easily verify the response to the customer.

Furthermore, the display processing unit 55 displays individual inquiry content corresponding to each of the plurality of analysis results displayed in the list on the conversation analysis screen 100. In the conversation analysis screen 100, the display processing unit 55 displays the analysis result for each inquiry received from the terminal 2 in the Room list area 101 and displays response content corresponding to the inquiry for each inquiry in the detailed conversation area 102. From the conversation analysis screen 100, the user can easily confirm the analysis result for each inquiry received from the terminal 2 and the response content corresponding to the inquiry for each inquiry.

Furthermore, in a case where the analysis result for each inquiry narrowed down on the basis of a specific index and displayed in the Room list area 101, the display processing unit 55 also narrows down the response content on the basis of the specific index and displays the response content in the detailed conversation area 102. As a result, the user can easily confirm the analysis result after narrowing down is performed and the response content.

Furthermore, in the Room list area 101, the display processing unit 55 distinguishes a response content indicating the inflow source and the response content indicating the guidance destination from other response content and displays the response content by using the inflow source/guidance destination icon 101a. As a result, the user can easily identify the response content of the inflow source and the response content of the guidance destination.

Furthermore, the display processing unit 55 displays a list of information indicating an interest of the user (customer) regarding the inquiry content and information indicating a reaction state of the user (customer) with respect to the interest in the VoC analysis screen 110 on the basis of the analysis result obtained by using a predetermined word included in the inquiry content as an index. From the VoC analysis screen 110, the user (analyzer) can easily confirm the interest of the user (customer) regarding the inquiry content and the reaction state with respect to the interest.

Furthermore, in the keyword appearance transition area 111 of the VoC analysis screen 110, as the information indicating the interest of the user (customer), an appearance transition of a predetermined word included in the inquiry content is displayed. Furthermore, in the negative/positive analysis area 113 of the VoC analysis screen 110, as the information indicating the reaction state of the user (customer) with respect to the interest, evaluation (negative/positive analysis) of the user (customer) based on the word dependent on the predetermined word is displayed. From the keyword appearance transition area 111, the user (analyzer) can confirm the interest of the user (customer) from the appearance transition of the predetermined word included in the inquiry content. Furthermore, from the negative/positive analysis area 113, the user (analyzer) can confirm the evaluation (negative/positive analysis) of the user (customer).

Furthermore, the display processing unit 55 displays a list of rankings of the number of appearances of the word included in the inquiry content in the keyword ranking area 112 of the VoC analysis screen 110. Furthermore, the display processing unit 55 displays a list of rankings of the number of appearances of a set of a predetermined word included in the inquiry content and a word dependent on the predetermined word in the dependency ranking area 114 of the VoC analysis screen 110. From this display, the user (analyzer) can easily confirm the ranking of the appearances of the word included in the inquiry content. Furthermore, the user (analyzer) can easily confirm the ranking of the combination (dependency set) of the words included in the inquiry content having the dependency.

Furthermore, the display processing unit 55 superimposes the plurality of analysis results obtained by analyzing the inquiry content received and collected by the chatbot of the host computer 3 from the terminal 2 on the basis of the plurality of indexes on the flow of the flow line analysis screen 90 based on the talk script in which the action of the chatbot is determined and displays a list, From the flow line analysis screen 90, the user can confirm the analysis result obtained by analyzing the inquiry content in the unmanned chat by the chatbot along the flow of the talk script.

Furthermore, regarding the branches included in the flow of the flow line analysis screen 90, the display processing unit 55 distinguishes the branch at which the reception of the chatbot ends and from which the procedure leaves from the flow and the branch where the inquiry about the satisfaction is made from other branches according to the leaving icon 92 and the answer content graph 93 and displays the distinguished branches. With these icons, the user can easily identify the branch from which the procedure leaves from the unmanned chat by the chatbot and the branch where the inquiry about the satisfaction is made in the flow of the flow line analysis screen 90.

Furthermore, the display processing unit 55 displays a list of statistical information of the inflow source and the guidance destination in a specific period unit and the breakdowns of the inflow source and the guidance destination in the inflow source and guidance destination analysis screen 80. From the inflow source and guidance destination analysis screen 80, the user can easily confirm, for example, the transitions of the inflow source and the guidance destination, for example, from the statistical information of the inflow source and the guidance destination in period units. Furthermore, the user can confirm details of the inflow source and the guidance destination from the breakdowns of the inflow source and the guidance destination.

Note that the respective components of each of the illustrated apparatuses and devices are not necessarily physically configured as illustrated in the drawings. For example, the specific aspects of separation and integration of each of the apparatuses and devices are not limited to the illustrated aspects, and all or a part of the apparatuses or devices can be functionally or physically separated and integrated in any unit, in accordance with various loads, use status, and the like.

Furthermore, various processing functions executed by the analyzer 5 may be entirely or optionally partially executed on a central processing unit (CPU) (or microcomputer, such as microprocessor unit (MPU) or micro controller unit (MCU)). Furthermore, it is needless to say that whole or any part of various processing functions may be executed by a program to be analyzed and executed on a CPU (or microcomputer, such as MPU or MCU), or on hardware by wired logic. In addition, various processing functions executed by the analyzer 5 may be executed by a plurality of computers in cooperation though cloud computing.

Meanwhile, the various types of processing described in the above embodiment can be achieved by execution of a prepared program on a computer. Thus, there will be described below an example of a computer (hardware) that executes a program with functions similar to the functions in the above embodiment, FIG. 14 is a block diagram illustrating an exemplary hardware configuration of the analyzer 5 according to the embodiment.

As illustrated in FIG. 14, the analyzer 5 includes a CPU 201 that executes various types of arithmetic processing, an input device 202 that receives data input, a monitor 203, and a speaker 204. Furthermore, the analyzer 5 includes a medium reading device 205 that reads a program and the like from a storage medium, an interface device 206 that is used for connecting to various devices, and a communication device 207 that connects communicative with an external device in a wired or wireless manner. Furthermore, the analyzer 5 further includes a RAM 208 for temporarily storing various types of information, and a hard disk device 209. Furthermore, each unit (201 to 209) in the analyzer 5 is connected to a bus 210.

The hard disk device 209 stores a program 211 used to execute various processing by the bot data analysis unit 51, the conversation extraction unit 52, the conversation analysis unit 53, the cleansing unit 54, the display processing unit 55, the input unit 56, the output unit 57, or the like described in the above embodiment. Furthermore, the hard disk device 209 stores various types of data 212 to which the program 211 refers. The input device 202 receives, for example, an input of operation information from an operator. The monitor 203 displays, for example, various screens operated by the operator. The interface device 206 is connected to, for example, a printing device or the like. The communication device 207 is connected to a communication network such as a Local Area Network (LAN), and exchanges various types of information with the external device via the communication network.

The CPU 201 reads the program 211 stored in the hard disk device 209 and develops and executes the program 211 on the RAM 208 so as to execute various processing related to the bot data analysis unit 51, the conversation extraction unit 52, the conversation analysis unit 53, the cleansing unit 54, the display processing unit 55, the input unit 56, the output unit 57, or the like Note that, the program 211 may not be prestored in the hard disk device 209. For example, the program 211 that is stored in a storage medium and can be read by the analyzer 5 may be read and executed. The storage medium which can be read by the analyzer 5 corresponds to, for example, a portable recording medium such as a CD-ROM, a DVD disk, and a universal serial bus (USB) memory, a semiconductor memory such as a flash memory, a hard disk drive, or the like. Alternatively, the program 211 may be prestored in a device connected to a public line, the Internet, a LAN, or the like, and the analyzer 5 may read the program 21 from the device to execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention

What is claimed is:

1. A non-transitory computer-readable recording medium having stored therein an analysis program for causing a computer to execute processing comprising:
displaying a list of a plurality of analysis results obtained by referring to a memory that stores inquiry content analyzed on the basis of a plurality of indexes including an inflow source for an inquiry and a guidance destination for the inquiry and analyzing the inquiry content on the basis of the plurality of indexes, in a case where an instruction to display the inquiry content received and collected from a plurality of terminals is received; and
performing narrowing down on other analysis results displayed in the list and displaying a plurality of analysis results after the narrowing down is performed, in addition to displaying an analysis result after narrowing down is performed on an analysis result in a case where narrowing down of analysis on any one of the plurality of analysis results displayed in the list is received.

2. The non-transitory computer-readable recording medium having stored therein the analysis program according to claim 1, for further causing a computer to execute processing comprising:
when individual inquiry content corresponding to the plurality of analysis results displayed in the list is displayed
displaying an analysis result for each inquiry received from the plurality of terminals; and
displaying response content corresponding to an inquiry for each inquiry.

3. The non-transitory computer-readable recording medium having stored therein the analysis program according to claim 2, wherein
in the processing for displaying the response content, in a case where an analysis result for each inquiry is narrowed down and displayed on the basis of a specific index, the response content is also narrowed down and displayed on the basis of the specific index.

4. The non-transitory computer-readable recording medium having stored therein the analysis program according to claim 2, wherein
in the processing for displaying the response content, response content indicating the inflow source and other response content are distinguished from each other and displayed.

5. The non-transitory computer-readable recording medium having stored therein the analysis program according to claim 2, wherein
in the processing for displaying the response content, response content indicating the guidance destination and other response content are distinguished from each other and displayed.

6. The non-transitory computer-readable recording medium having stored therein the analysis program according to claim 1, wherein
in a case where word analysis on inquiry content corresponding to the plurality of analysis results displayed in the list is received, information indicating an interest of a user regarding the inquiry content and information indicating a reaction state of the user with respect to the interest are displayed in a list on the basis of an analysis result obtained by using a predetermined word included in the inquiry content as an index.

7. The non-transitory computer-readable recording medium having stored therein the analysis program according to claim 6, wherein
the information indicating the interest of the user is an appearance transition of the predetermined word included in the inquiry content, and the information indicating the reaction state of the user with respect to the interest is an evaluation result based on a word dependent on the predetermined word.

8. The non-transitory computer-readable recording medium having stored therein the analysis program according to claim 6, wherein
in a case where the word analysis is received, a ranking of the number of appearances of the word included in the inquiry content and a ranking of the number of appearances of a set of the word and a word dependent on the word are displayed in a list.

9. The non-transitory computer-readable recording medium having stored therein the analysis program according to claim 1, wherein
in a case where flow line analysis of inquiry content corresponding to the plurality of analysis results displayed in a list is received, a plurality of analysis results obtained by analyzing inquiry content received and corrected by a chatbot from the plurality of terminals on the basis of the plurality of indexes is displayed in a list while being superimposed on a flow of an inquiry based on a talk script in which an action of the chatbot is determined.

10. The non-transitory computer-readable recording medium having stored therein the analysis program according to claim 9, wherein
in a case where the flow line analysis is received, a branch at which reception of the chatbot ends and a procedure leaves from the inquiry flow and a branch where an inquiry regarding satisfaction is made among branches in the inquiry flow are distinguished from other branches and displayed.

11. The non-transitory computer-readable recording medium having stored therein the analysis program according to claim 1, wherein
in a case where analysis on an inflow source and a guidance destination of the inquiry content corresponding to the plurality of analysis results displayed in the list is received, as the plurality of analysis results, statistical information of the inflow source and the guidance destination in specific period units and breakdowns of the inflow source and the guidance destination are displayed in a list.

12. An analysis method for causing a computer to execute processing comprising:
displaying a list of a plurality of analysis results obtained by referring to a memory that stores inquiry content analyzed on the basis of a plurality of indexes including an inflow source for an inquiry and a guidance destination for the inquiry and analyzing the inquiry content on the basis of the plurality of indexes, in a case where an instruction to display the inquiry content received and collected from a plurality of terminals is received; and
performing narrowing down on other analysis results displayed in the list and displaying a plurality of analysis results after the narrowing down is performed, in addition to displaying an analysis result after narrowing down is performed on an analysis result in a case where narrowing down of analysis on any one of the plurality of analysis results displayed in the list is received.

13. The analysis method according to claim 12, further causing the computer to execute processing comprising:
displaying an analysis result for each inquiry received from the plurality of terminals and displaying response content corresponding to an inquiry for each inquiry when individual inquiry content corresponding to the plurality of analysis results displayed in the list is displayed.

14. The analysis method according to claim 13, wherein
in the processing for displaying the response content, in a case where an analysis result for each inquiry is narrowed down and displayed on the basis of a specific index, the response content is also narrowed down and displayed on the basis of the specific index.

15. The analysis method according to claim 13, wherein
in the processing for displaying the response content, response content indicating the inflow source and other response content are distinguished from each other and displayed.

16. The analysis method according to claim 13, wherein
in the processing for displaying the response content, response content indicating the guidance destination and other response content are distinguished from each other and displayed.

17. The analysis method according to claim 12, wherein
in a case where word analysis on inquiry content corresponding to the plurality of analysis results displayed in the list is received, information indicating an interest of a user regarding the inquiry content and information indicating a reaction state of the user with respect to the interest are displayed in a list on the basis of an analysis result obtained by using a predetermined word included in the inquiry content as an index.

18. The analysis method according to claim 12, wherein
in a case where flow line analysis of inquiry content corresponding to the plurality of analysis results displayed in a list is received, a plurality of analysis results obtained by analyzing inquiry content received and corrected by a chatbot from the plurality of terminals on the basis of the plurality of indexes is displayed in a list while being superimposed on a flow of an inquiry based on a talk script in which an action of the chatbot is determined.

19. The analysis method according to claim 12, wherein
in a case where analysis on an inflow source and a guidance destination of the inquiry content corresponding to the plurality of analysis results displayed in the list is received, as the plurality of analysis results, statistical information of the inflow source and the guidance destination in specific period units and breakdowns of the inflow source and the guidance destination are displayed in a list.

20. An analyzer comprising:
a memory; and
a processor coupled to the memory and configured to:
receive an instruction input from a user; and
display a list of a plurality of analysis results obtained by referring to a memory that stores inquiry content analyzed on the basis of a plurality of indexes including an inflow source for an inquiry and a guidance destination for the inquiry and analyzing the inquiry content on the basis of the plurality of indexes, in a case where an instruction to display the inquiry content received and collected from a plurality of terminals is received and perform narrowing down on other analysis results displayed in the list and displays a plurality of analysis results after the narrowing down is performed, in addition to displaying an analysis result after narrowing down is performed on an analysis result in a case where narrowing down of analysis on any one of the plurality of analysis results displayed in the list is received.
